(19) United States
(12) Patent Application Publication
(10) Pub. No.: US 2026/0329855 A1
(43) Pub. Date: Oct. 22, 2026

(54) SYSTEM AND METHOD FOR QUERY CLASSIFICATION AND SIMILARITY-BASED SQL RETRIEVAL USING LARGE LANGUAGE MODELS

(71) Applicant: The Toronto-Dominion Bank, Toronto (CA)

(72) Inventors: Valentin Victor VILLECROZE, Toronto (CA); Anthony Lawrence CATERINI, Toronto (CA); Laura DOKTOROVA, Toronto (CA); Sangeeta MATHEW, Mississauga (CA); Shu Ying CHEN, Markham (CA); Artem BURMISTROV, Toronto (CA); Bhargava KUMAR, Jersey City, NJ (US); Christopher William RUBICH, Riverside, CT (US); Julia Lane SHELANSKI, NY, NY (US); Norma Cabildo VALLES, Whitby (CA); Pratibha DEVARE, West Caldwell, NJ (US); Gio Giorgio ABOU JAOUDE, NY, NY (US); Maksims VOLKOVS, Toronto (CA)

(73) Assignee: The Toronto-Dominion Bank, Toronto, ON (CA)

(21) Appl. No.: 19/182,109

(22) Filed: Apr. 17, 2025

(51) Int. Cl. G06F 16/242; G06F 16/28

(52) U.S. Cl. CPC G06F 16/2433; G06F 16/285

(57) ABSTRACT

A computer system comprises at least one processor; and a memory coupled to the at least one processor and storing processor-executable instructions which, when executed by the at least one processor, configure the at least one processor to engage a classifier to classify a query and apply a dataset filter to a vector database based on a classification of the query; simultaneously identify at least one entity from the query; modify the query to replace the identified at least one entity from the query with a generic placeholder; perform a similarity search using the modified query to identify at least one similar query within the filtered dataset in the vector database; and extract a Structured Query Language (SQL) query associated with the identified at least one similar query and provide the SQL to a large language model to generate a response to the query.

### TECHNICAL FIELD

The present application relates to systems and methods for query classification and similarity-based SQL retrieval using large language models.

### BACKGROUND

Retrieval systems are difficult to implement, with an example of the difficulty including the trade off between speed and sorting large amounts of data, another example being the difficulty of providing time sensitive outputs in response to determining the sorted document or corpus, etc. One example of a retrieval system is a Retrieval-Augmented Generation (RAG) system, which can be based on an AI technique that combines two steps: retrieving information from a large collection of documents, referred to as a document corpus, and using that information to generate an accurate response. Instead of relying only on what the model was trained on, RAG searches a document database to find relevant details before generating an answer. This helps reduce errors and allows the model to stay updated without needing constant retraining.

However, digitized retrieval systems, such as RAG systems, require large amounts of computing power. Searching large document sets quickly demands more optimized search techniques, while generating responses still relies on heavy AI models that need large amounts of capacity provided by rare and expensive Graphics Processing Units (GPUs).

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 is a schematic diagram outlining various components of an engine; and

FIG. 4 shows, in flowchart form, an example method for entity disambiguation;

FIG. 5 shows, in flowchart form, an example method for performing a similarity search within a vector database;

FIG. 6 shows, in flowchart form, an example method for generating at least one metadata tag for a document ingested into a corpus;

FIG. 7 shows, in flowchart form, an example method for updating a dynamic metadata tag;

FIG. 8 shows, in flowchart form, an example method for applying an entity metadata filter;

FIG. 9 shows, in flowchart form, an example method for applying a temporal metadata filter;

FIG. 10 shows, in flowchart form, an example method for document retrieval;

FIG. 11 shows, in flowchart form, an example method for providing documents to an LLM;

FIG. 12 is a schematic diagram outlining various components of another engine.

FIG. 13 shows, in flowchart form, an example method for extracting an SQL query;

FIG. 14 shows, in flowchart form, an example method for adding a generified query to a database; and

FIG. 15 is a schematic diagram outlining various components of another engine.

Like reference numerals are used in the drawings to denote like elements and features.

### DETAILED DESCRIPTION OF VARIOUS EMBODIMENTS

Accordingly, in one aspect there is provided a computer system comprising at least one processor, and a memory coupled to the at least one processor and storing processor-executable instructions which, when executed by the at least one processor, configure the at least one processor to engage a large language model to extract entity metadata from a query, embed the entity metadata into a metadata vector, compare the metadata vector to a vector database to identify a closest entity, and replace the entity metadata with the identified closest entity prior to document retrieval.

In one or more embodiments, when comparing the metadata vector to the vector database to identify the closest entity, the instructions, when executed by the at least one processor, further configure the at least one processor to compute a similarity score between the metadata vector and stored vectors in the vector database, select a stored vector based on the similarity score, and retrieve an entity associated with the selected stored vector as the closest entity.

In one or more embodiments, the similarity score is computed using one of cosine similarity or Euclidean distance.

In one or more embodiments, when comparing the metadata vector to the vector database to identify the closest entity, the instructions, when executed by the at least one processor, further configure the at least one processor to perform an exact match search within the vector database.

In one or more embodiments the instructions, when executed by the at least one processor, further configure the at least one processor to determine that the metadata vector exactly matches a stored vector in the vector database and retrieve an entity associated with the stored vector as the closest entity.

In one or more embodiments the instructions, when executed by the at least one processor, further configure the at least one processor to determine that the metadata vector does not exactly match a stored vector in the vector database, and in response to determining that the metadata vector does not exactly match the stored vector in the vector database, perform a similarity search within the vector database.

In one or more embodiments, when performing the similarity search, the instructions, when executed by the at least one processor, further configure the at least one processor to compute a similarity score between the metadata vector and stored vectors in the vector database, select a stored vector based on the similarity score, and retrieve an entity associated with the selected stored vector as the closest entity.

In one or more embodiments, the vector database includes a plurality of stored vectors, each of which is associated with a particular entity.

In one or more embodiments the instructions, when executed by the at least one processor, further configure the at least one processor to use the corrected entity metadata for document retrieval.

According to another aspect there is provided a method comprising engaging a large language model to extract entity metadata from a query, embedding the entity metadata into a metadata vector, comparing the metadata vector to a vector database to identify a closest entity, and replacing the entity metadata with the identified closest entity prior to document retrieval.

In one or more embodiments, when comparing the metadata vector to the vector database to identify the closest entity, the method further comprises computing a similarity score between the metadata vector and stored vectors in the vector database, selecting a stored vector based on the similarity score, and retrieving an entity associated with the selected stored vector as the closest entity.

In one or more embodiments, the similarity score is computed using one of cosine similarity or Euclidean distance.

In one or more embodiments, when comparing the metadata vector to the vector database to identify the closest entity, the method further comprises performing an exact match search within the vector database.

In one or more embodiments, the method further comprises determining that the metadata vector exactly matches a stored vector in the vector database and retrieving an entity associated with the selected stored vector as the closest entity.

In one or more embodiments, the method further comprises determining that the metadata vector does not exactly match a stored vector in the vector database, and in response to determining that the metadata vector does not exactly match the stored vector in the vector database, performing a similarity search within the vector database.

In one or more embodiments, when performing the similarity search, the method further comprises computing a similarity score between the metadata vector and stored vectors in the vector database, selecting a stored vector based on the similarity score, and retrieving an entity associated with the selected stored vector as the closest entity.

In one or more embodiments, the vector database includes a plurality of stored vectors, each of which is associated with a particular entity.

In one or more embodiments, the method further comprises using the corrected entity metadata for document retrieval.

According to another aspect there is provided a non-transitory computer readable storage medium comprising computer-executable instructions which, when executed, configure at least one processor to engage a large language model to extract entity metadata from a query, embed the entity metadata into a metadata vector, compare the metadata vector to a vector database to identify a closest entity, and replace the entity metadata with the identified closest entity prior to document retrieval.

According to another aspect there is provided a computer system comprising at least one processor, and a memory coupled to the at least one processor and storing processor-executable instructions which, when executed by the at least one processor, configure the at least one processor to identify a closest entity based on entity metadata extracted from a query by a large language model, generate an entity metadata filter based on the identified closest entity, and apply the entity metadata filter to a vector database to identify a subset of vectors in the vector database.

In one or more embodiments, the vector database stores a plurality of vectors.

In one or more embodiments, each vector of the plurality of vectors is associated with a document in a corpus.

In one or more embodiments the instructions, when executed by the at least one processor, further configure the at least one processor to convert the document in the corpus into a vector using an embedding model, and store the vector in the vector database.

In one or more embodiments the instructions, when executed by the at least one processor, further configure the at least one processor to generate at least one metadata tag for the document in the corpus, and store the at least one metadata tag in the vector database in association with the vector for the document.

In one or more embodiments, the vector database stores at least one metadata tag associated with each vector of the plurality of vectors.

In one or more embodiments, the at least one metadata tag includes at least one of an entity metadata tag, a temporal metadata tag, a domain-specific metadata tag, a geospatial metadata tag, an uncertainty metadata tag, a document structure metadata tag, an authorship metadata tag, a source credibility metadata tag, a summarization metadata tag, a document type metadata tag, an interlinking metadata tag, or an accessibility metadata tag.

In one or more embodiments, the at least one metadata tag is selected from a list of predefined metadata tags.

In one or more embodiments the instructions, when executed by the at least one processor, further configure the at least one processor to generate another metadata filter based on another type of metadata, and apply the other metadata filter to the subset of vectors to identify a smaller subset of vectors.

In one or more embodiments, the entity metadata filter is retrieved from the vector database based on the identified closest entity.

According to another aspect there is provided a computer-implemented method comprising identifying a closest entity based on entity metadata extracted from a query by a large language model, generating an entity metadata filter based on the identified closest entity, and applying the entity metadata filter to a vector database to identify a subset of vectors in the vector database.

In one or more embodiments, the vector database stores a plurality of vectors.

In one or more embodiments, each vector of the plurality of vectors is associated with a document in a corpus.

In one or more embodiments, the method further comprises converting the document in the corpus into a vector using an embedding model, and storing the vector in the vector database.

In one or more embodiments, the method further comprises generating at least one metadata tag for the document in the corpus, and storing the at least one metadata tag in the vector database in association with the vector for the document.

In one or more embodiments, the vector database stores at least one metadata tag associated with each vector of the plurality of vectors.

In one or more embodiments, the at least one metadata tag includes at least one of an entity metadata tag, a temporal metadata tag, a domain-specific metadata tag, a geospatial metadata tag, an uncertainty metadata tag, a document structure metadata tag, an authorship metadata tag, a source credibility metadata tag, a summarization metadata tag, a document type metadata tag, an interlinking metadata tag, or an accessibility metadata tag.

In one or more embodiments, the at least one metadata tag is selected from a list of predefined metadata tags.

In one or more embodiments, the method further comprises generating another metadata filter based on another type of metadata, and applying the other metadata filter to the subset of vectors to identify a smaller subset of vectors.

According to another aspect there is provided a non-transitory computer readable storage medium comprising computer-executable instructions which, when executed, configure at least one processor to identify a closest entity based on entity metadata extracted from a query by a large language model, generate an entity metadata filter based on the identified closest entity, and apply the entity metadata filter to a vector database to identify a subset of vectors in the vector database.

According to another aspect there is provided a computer system comprising at least one processor, and a memory coupled to the at least one processor and storing processor-executable instructions which, when executed by the at least one processor, configure the at least one processor to detect that a new document has been added to a corpus, engage a large language model to analyze the new document to determine at least one metadata tag for the new document, assign the at least one metadata tag and a temporal metadata tag that includes a future date to the new document, identify at least one previous document within the corpus having the at least one metadata tag, and update a temporal metadata tag of the at least one previous document to include a current date.

In one or more embodiments the instructions, when executed by the at least one processor, further configure the at least one processor to convert the new document into a vector using an embedding model, and store the vector in a vector database.

In one or more embodiments the instructions, when executed by the at least one processor, further configure the at least one processor to store the at least one metadata tag and the temporal metadata tag in the vector database in association with the vector for the new document.

In one or more embodiments, the at least one metadata tag includes at least one of an entity metadata tag, a domain-specific metadata tag, a geospatial metadata tag, an uncertainty metadata tag, a document structure metadata tag, an authorship metadata tag, a source credibility metadata tag, a summarization metadata tag, a document type metadata tag, an interlinking metadata tag, or an accessibility metadata tag.

In one or more embodiments, when identifying the at least one previous document within the corpus having the at least one metadata tag, the instructions, when executed by the at least one processor, further configure the at least one processor to search a vector database using the at least one metadata tag, and identify the at least one previous document based on the search.

In one or more embodiments, when identifying the at least one previous document within the corpus having the at least one metadata tag, the instructions, when executed by the at least one processor, further configure the at least one processor to search the vector database using the at least one metadata tag and the temporal metadata tag, and identify the at least one previous document based on the search.

In one or more embodiments, the temporal metadata tag of the at least one previous document is modified from the future date to the current date.

In one or more embodiments, the temporal metadata tag is used to indicate that the new document contains the most recent data for a topic or entity associated with the at least one metadata tag.

In one or more embodiments, the future date is predefined as a far-future placeholder date.

In one or more embodiments the instructions, when executed by the at least one processor, further configure the at least one processor to receive an indication that the new document has been added to the corpus.

According to another aspect there is provided a computer-implemented method comprising detecting that a new document has been added to a corpus, engaging a large language model to analyze the new document to determine at least one metadata tag for the new document, assigning the at least one metadata tag and a temporal metadata tag that includes a future date to the new document, identifying at least one previous document within the corpus having the at least one metadata tag, and updating a temporal metadata tag of the at least one previous document to include a current date.

In one or more embodiments, the method further comprises converting the new document into a vector using an embedding model, and storing the vector in a vector database.

In one or more embodiments, the method further comprises storing the at least one metadata tag and the temporal metadata tag in the vector database in association with the vector for the new document.

In one or more embodiments, the at least one metadata tag includes at least one of an entity metadata tag, a domain-specific metadata tag, a geospatial metadata tag, an uncertainty metadata tag, a document structure metadata tag, an authorship metadata tag, a source credibility metadata tag, a summarization metadata tag, a document type metadata tag, an interlinking metadata tag, or an accessibility metadata tag.

In one or more embodiments, when identifying the at least one previous document within the corpus having the at least one metadata tag, the method further comprises searching a vector database using the at least one metadata tag, and identifying the at least one previous document based on the search.

In one or more embodiments, when identifying the at least one previous document within the corpus having the at least one metadata tag, the method further comprises searching the vector database using the at least one metadata tag and the temporal metadata tag, and identifying the at least one previous document based on the search.

In one or more embodiments, the temporal metadata tag of the at least one previous document is modified from the future date to the current date.

In one or more embodiments, the temporal metadata tag is used to indicate that the new document contains the most recent data for a topic or entity associated with the at least one metadata tag.

In one or more embodiments, the future date is predefined as a far-future placeholder date.

According to another aspect, there is provided a non-transitory computer readable storage medium comprising computer-executable instructions which, when executed, configure at least one processor to detect that a new document has been added to a corpus, engage a large language model to analyze the new document to determine at least one metadata tag for the new document, assign the at least one metadata tag and a temporal metadata tag that includes a future date to the new document, identify at least one previous document within the corpus having the at least one metadata tag, and update a temporal metadata tag of the at least one previous document to include a current date.

According to another aspect there is provided a computer system comprising at least one processor, and a memory coupled to the at least one processor and storing processor-executable instructions which, when executed by the at least one processor, configure the at least one processor to identify a temporal metadata tag based on temporal metadata extracted from a query by a large language model, generate a temporal metadata filter based on the identified temporal metadata tag, and apply the temporal metadata filter to a vector database to identify a subset of vectors in the vector database.

In one or more embodiments, the vector database stores a plurality of vectors.

In one or more embodiments, each vector of the plurality of vectors is associated with a document in a corpus.

In one or more embodiments, the vector database stores at least one temporal metadata tag associated with each vector in the vector database.

In one or more embodiments, the temporal metadata tag identifies one of a current date or a particular date.

In one or more embodiments the instructions, when executed by the at least one processor, further configure the at least one processor to identify at least one other metadata tag based on metadata extracted from the query, generate at least one other metadata filter based on the identified at least one other metadata tag, and apply the at least one other metadata filter to the vector database to identify a smaller subset of vectors in the vector database.

In one or more embodiments, the at least one other metadata tag includes at least one of an entity metadata tag, an intent metadata tag, a data type metadata tag, or a domain-specific metadata tag.

In one or more embodiments the instructions, when executed by the at least one processor, further configure the at least one processor to identify at least one vector from the subset of vectors in the vector database for the query, retrieve a document associated with the identified at least one vector, and provide the retrieved document to the large language model to generate a response to the query.

In one or more embodiments, the temporal metadata filter identifies vectors within the vector database that have temporal metadata tags that include a future date.

In one or more embodiments, the temporal metadata filter identifies vectors within the vector database that have temporal metadata tags that include a past date.

According to another aspect there is provided a computer-implemented method comprising identifying a temporal metadata tag based on temporal metadata extracted from a query by a large language model, generating a temporal metadata filter based on the identified temporal metadata tag, and applying the temporal metadata filter to a vector database to identify a subset of vectors in the vector database.

In one or more embodiments, the method further comprises the vector database storing a plurality of vectors.

In one or more embodiments, the method further comprises each vector of the plurality of vectors being associated with a document in a corpus.

In one or more embodiments, the method further comprises the vector database storing at least one temporal metadata tag associated with each vector in the vector database.

In one or more embodiments, the temporal metadata tag identifies one of a current date or a particular date.

In one or more embodiments, the method further comprises identifying at least one other metadata tag based on metadata extracted from the query, generating at least one other metadata filter based on the identified at least one other metadata tag, and applying the at least one other metadata filter to the vector database to identify a smaller subset of vectors in the vector database.

In one or more embodiments, the at least one other metadata tag includes at least one of an entity metadata tag, an intent metadata tag, a data type metadata tag, or a domain-specific metadata tag.

In one or more embodiments, the method further comprises identifying at least one vector from the subset of vectors in the vector database for the query, retrieving a document associated with the identified at least one vector, and providing the retrieved document to the large language model to generate a response to the query.

In one or more embodiments, the temporal metadata filter identifies vectors within the vector database that have temporal metadata tags that include a future date.

According to another aspect there is provided a non-transitory computer readable storage medium comprising computer-executable instructions which, when executed, configure at least one processor to identify a temporal metadata tag based on temporal metadata extracted from a query by a large language model, generate a temporal metadata filter based on the identified temporal metadata tag, and apply the temporal metadata filter to a vector database to identify a subset of vectors in the vector database.

According to another aspect there is provided a computer system comprising at least one processor, and a memory coupled to the at least one processor and storing processor-executable instructions which, when executed by the at least one processor, configure the at least one processor to apply at least one metadata filter to a vector database to identify a subset of vectors in the vector database, apply temporal proximity detection to rank the identified subset of vectors in the vector database, select a predefined number of top ranked vectors and retrieve at least one document associated with each selected vector, provide the retrieved at least one document associated with a highest ranked vector to a large language model to generate a response based on metadata extracted from a query, and provide the retrieved at least one document associated with the predefined number of top ranked vectors to the large language model for summarization.

In one or more embodiments the instructions, when executed by the at least one processor, further configure the at least one processor to identify at least one metadata tag based on the metadata extracted from the query by the large language model, and generate the at least one metadata filter based on the at least one metadata tag.

In one or more embodiments, the metadata extracted from the query includes at least one of entity metadata, intent metadata, temporal metadata, action metadata, data type metadata, or domain-specific metadata.

In one or more embodiments, the metadata extracted from the query includes entity metadata.

In one or more embodiments, the at least one document associated with the highest ranked vector is a most recent document.

In one or more embodiments, the at least one document associated with the highest ranked vector is a most relevant document.

In one or more embodiments, the at least one document associated with the highest ranked vector includes a most recent value associated with the metadata extracted from the query.

In one or more embodiments, the at least one document associated with the top ranked vectors include data relevant to the metadata extracted from the query.

In one or more embodiments, the vector database stores a plurality of vectors.

In one or more embodiments, each vector of the plurality of vectors is associated with a document in a corpus.

According to another aspect there is provided a computer-implemented method comprising applying at least one metadata filter to a vector database to identify a subset of vectors in the vector database, applying temporal proximity detection to rank the identified subset of vectors in the vector database, selecting a predefined number of top ranked vectors and retrieve at least one document associated with each selected vector, providing the retrieved at least one document associated with a highest ranked vector to a large language model to generate a response based on metadata extracted from a query, and providing the retrieved at least one document associated with the predefined number of top ranked vectors to the large language model for summarization.

In one or more embodiments, the method further comprises identifying at least one metadata tag based on the metadata extracted from the query by the large language model, and generating the at least one metadata filter based on the at least one metadata tag.

In one or more embodiments, the metadata extracted from the query includes entity metadata.

In one or more embodiments, the at least one document associated with the highest ranked vector is a most recent document.

In one or more embodiments, the at least one document associated with the highest ranked vector is a most relevant document.

In one or more embodiments, the at least one document associated with the highest ranked vector includes a most recent value associated with the metadata extracted from the query.

In one or more embodiments, the at least one document associated with the top ranked vectors include data relevant to the metadata extracted from the query.

In one or more embodiments, the vector database stores a plurality of vectors.

In one or more embodiments, each vector of the plurality of vectors is associated with a document in a corpus.

According to another aspect there is provided a non-transitory computer readable storage medium comprising computer-executable instructions which, when executed, configure at least one processor to apply at least one metadata filter to a vector database to identify a subset of vectors in the vector database, apply temporal proximity detection to rank the identified subset of vectors in the vector database, select a predefined number of top ranked vectors and retrieve at least one document associated with each selected vector, provide the retrieved at least one document associated with a highest ranked vector to a large language model to generate a response based on metadata extracted from a query, and provide the retrieved at least one document associated with the predefined number of top ranked vectors to the large language model for summarization.

According to another aspect there is provided a computer system comprising at least one processor and a memory coupled to the at least one processor, the memory storing processor-executable instructions which, when executed by the at least one processor, configure the at least one processor to engage a classifier to classify a query and apply a dataset filter to a vector database based on the classification of the query, simultaneously identify at least one entity from the query, modify the query to replace the identified at least one entity from the query with a generic placeholder, perform a similarity search using the modified query to identify at least one similar query within the filtered dataset in the vector database, and extract a Structured Query Language (SQL) query associated with the identified at least one similar query and provide the SQL to a large language model to generate a response to the query.

In one or more embodiments, the vector database stores a plurality of vectors.

In one or more embodiments, each vector includes an embedded query that is stored in association with a dataset tag and an SQL query.

In one or more embodiments, the processor is further configured to embed the modified query into a query vector.

In one or more embodiments, when performing the similarity search, the processor is further configured to compute a similarity score between the query vector and stored vectors in the vector database, and select at least one stored vector based on the similarity score.

In one or more embodiments, the similarity score is computed using one of cosine similarity or Euclidean distance.

In one or more embodiments, the classifier is trained to classify queries based on predefined dataset tags.

In one or more embodiments, the at least one similar query includes a predefined number of similar queries.

In one or more embodiments the instructions, when executed by the at least one processor, further configure the at least one processor to determine a dataset tag based on the classification of the query, embed the modified query into a query vector, determine an SQL query for the modified query, and store the embedded modified query in the vector database in association with the SQL query and the dataset tag.

In one or more embodiments, the processor is further configured to engage a disambiguation engine to identify the at least one entity from the query.

According to another aspect there is provided a computer-implemented method comprising engaging a classifier to classify a query and apply a dataset filter to a vector database based on the classification of the query, simultaneously identifying at least one entity from the query, modifying the query to replace the identified at least one entity from the query with a generic placeholder, performing a similarity search using the modified query to identify at least one similar query within the filtered dataset in the vector database, and extracting a Structured Query Language (SQL) query associated with the identified at least one similar query and providing the SQL to a large language model to generate a response to the query.

In one or more embodiments, the method further comprises embedding the modified query into a query vector.

In one or more embodiments, the method further comprises computing a similarity score between the query vector and stored vectors in the vector database, and selecting at least one stored vector based on the similarity score.

In one or more embodiments, the similarity score is computed using one of cosine similarity or Euclidean distance.

In one or more embodiments, the classifier is trained to classify queries based on predefined dataset tags.

In one or more embodiments, the at least one similar query includes a predefined number of similar queries.

In one or more embodiments, the method further comprises determining a dataset tag based on the classification of the query, embedding the modified query into a query vector, determining an SQL query for the modified query, and storing the embedded modified query in the vector database in association with the SQL query and the dataset tag.

According to another aspect there is provided a non-transitory computer-readable storage medium comprising computer-executable instructions which, when executed, configure at least one processor to engage a classifier to classify a query and apply a dataset filter to a vector database based on the classification of the query, simultaneously identify at least one entity from the query, modify the query to replace the identified at least one entity from the query with a generic placeholder, perform a similarity search using the modified query to identify at least one similar query within the filtered dataset in the vector database, and extract a Structured Query Language (SQL) query associated with the identified at least one similar query and provide the SQL to a large language model to generate a response to the query.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

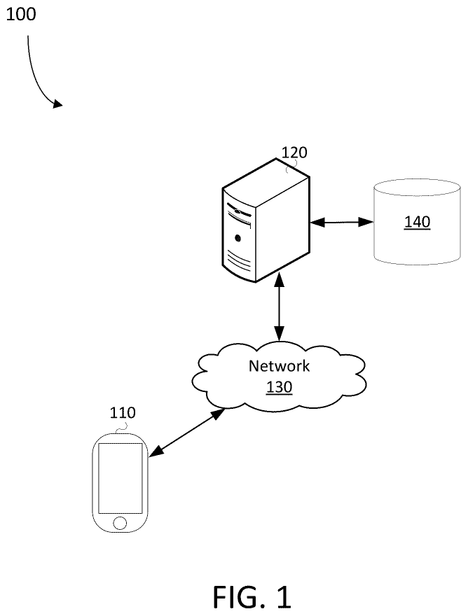

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may take a variety of forms including, for example, a mobile communication device such as a smartphone, a tablet computer, a wearable computer (such as a head-mounted display or smartwatch), a laptop or desktop computer, or a computing device of another type. The computing device 110 may store software instructions that cause the computing device 110 to establish communications with the server computer system 120.

The server computer system 120 may include or be in communication with a data store 140, such as a memory or other memory store. The memory may store a knowledge base, such as a document corpus. The document corpus is a set of documents from which a response to a query may be generated.

The document corpus may include a diverse set of documents. These documents may be structured and/or unstructured. The documents may include publicly available resources and/or private, organization-specific data. Public sources may include Wikipedia articles, news reports, research papers, legal texts, financial reports, and government regulations, which provide general knowledge and domain-specific information. Other types of documents may also be used. Additionally, scientific and technical literature, such as patents, engineering documentation, and API guides may be included in the document corpus.

At least some documents in the document corpus may be private or restricted, accessible only within a specific organization or operating environment. These can include corporate knowledge bases, internal wikis, customer support FAQs, employee handbooks, product manuals, proprietary research reports, etc. In industries like healthcare, law, and finance, confidential documents such as medical records, legal case files, internal compliance reports, and strategic business documents may be integrated while ensuring strict access control. Conversational data, such as chat transcripts, customer service logs, and internal emails, may also be included in private corpora.

In cases where sensitive data is involved in the document corpus, access to the corpus must be carefully managed, with privacy-preserving techniques like differential privacy, encryption, access control mechanisms, and secure APIs.

The document corpus may include documents represented in a text-based format, such as, for example, Microsoft Word™ documents, PDF documents, XML documents, plain text documents, HTML documents, LaTeX™ documents, JSON documents, source code files (e.g., .py, .java, .cpp, cjs, .html, .css, .sh, .sql, etc.), Rich Text Format (RTF), e-book documents (.epub, .mobi, .pdf, etc.), email documents (e.g., .eml, .msg, .mbox, etc.), spreadsheet documents, slide decks (e.g., .ppt), and/or documents of another type.

The data store 140 or memory may also store other data, such as a query set. The query set may be a synthetic query set, in at least some implementations. In some implementations, the data store 140 may include real queries, which may be queries extracted from a chatbot or other operator interface which allows for inputting of queries.

The data store 140 may, additionally or alternatively, store training data. The nature of the training data will depend on the nature of the model being trained and the nature of the training data will be understood from the discussion of methods described herein.

The data store 140 may, in some cases, include multiple data stores or elements, some or all of which may be remote from the server computer system 120.

The data store 140 may, additionally or alternatively, store one or more models. The models may be trained computational models that learn patterns from data, such as the training data, to make predictions, generate outputs or perform tasks. The models may be artificial intelligence (AI) models that are built using machine learning, in some implementations.

The server computer system 120 may provide an artificial intelligence engine by implementing one or more of the models. The server computer system 120 may, in some implementations, operate as or provide a Retrieval-Augmented Generation (RAG) system. ARAG system uses a knowledge base, such as the document corpus, to generate responses to queries. The queries may be queries received via a query interface. The query interface may be a user interface that is operated by an operator. The query interface may be output on the computing device 110. The operator may be of any one of a number of types and the nature of the operator will depend on the specific deployment scenario. By way of example, the operators may include customers, website visitors, students, researchers, employees, managers, executives, customer support agents, sales representatives, software developers, engineers, data scientists, ai engineers, it support, system administrators, doctors, medical researchers, lawyers, legal researchers, compliance officers, government officials, law enforcement, investigators, financial analysts, banking professionals, accountants, tax consultants, journalists, writers, marketing specialists, SEO specialists, video creators, podcast creators, online shoppers, retail store employees, supply chain managers, teachers, educators, corporate trainers, chatbots, virtual assistants, automated research tools.

In at least some implementations, the server computer system 120 may integrate the RAG with a chatbot. The RAG may enhance the chatbot's ability to provide accurate, contextually relevant responses. When a user submits a query, the chatbot may process and convert it into an embedding vector using a pre-trained model. This embedding may then be used to search a vector database containing precomputed document embeddings, retrieving the most relevant documents from a knowledge base that may include FAQs, product manuals, policies, or support articles. The retrieved documents may, in at least some implementations, be re-ranked with a re-ranker. The retrieved documents may then be passed as context to a model, such as a large language model (LLM), which generates a response by combining the retrieved information with the user's query.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

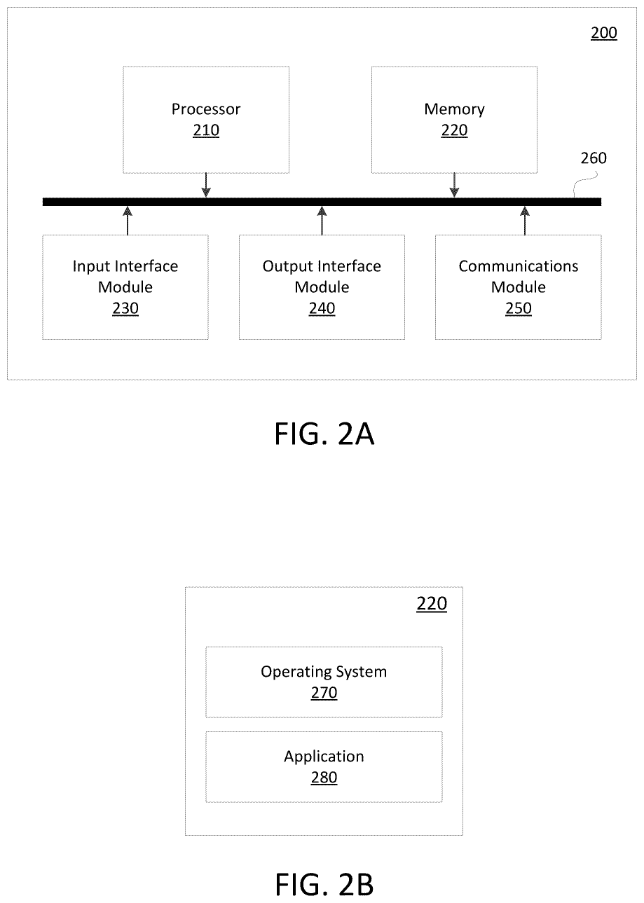

FIG. 2A is a high-level operation diagram of an example computer device 200. In some embodiments, the example computer device 200 may be exemplary of one or more of the computing device 110 and/or the server computer system 120. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi (™), using Bluetooth (™) or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS™, Google Android™, Linux™, Microsoft Windows™, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations.

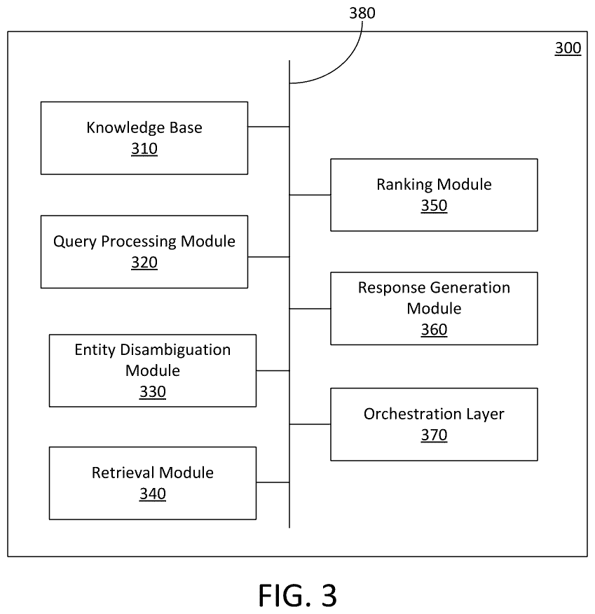

FIG. 3 is an example schematic diagram outlining various components of an engine 300. The engine 300 may be provided by or on the server computer system 120. In at least some implementations, the engine 300 may be provided on multiple computer systems. These multiple systems may operate in a cooperative manner. In at least some implementations, one or more of the models or modules that are illustrated as being provided in the engine 300 may, instead, be provided on another system, including on a third-party system.

The engine 300 may also be referred to as an artificial intelligence system. The engine may, in some implementations, operate as a retrieval-augmented generation (RAG) system and/or a training system.

The engine 300 may include one or more modules and/or models. In the illustrated example, the engine 300 includes a knowledge base 310, a query processing module 320, an entity disambiguation module 330, a retrieval module 340, a ranking module 350, a response generation module 360, and an orchestration layer 370. The various modules and/or models may communicate over a pipeline 380.

The knowledge base 310 may include or may communicate with a data store such as a vector database. The knowledge base 310 includes or otherwise provides access to a document corpus that may be queried for response generation. The document corpus may store structured and unstructured data, which may be embedded into vector representations for efficient retrieval.

Documents added to the knowledge base 310 may be converted into vector representations using an embedding model. The embedding model may process the document content and may generate a vector that captures the semantic meaning of the document. The vector is stored in the knowledge base 310 along with associated metadata tags for retrieval.

Documents added to the knowledge base 310 may be automatically processed to generate metadata tags. The system may analyze the document content to extract metadata tags such as for example entity metadata tags and temporal metadata tags. Entity metadata tags may represent key entities (organizations, locations, etc.) identified within the document. Temporal metadata tags may represent timestamps, time ranges, etc. The metadata tags may be stored in association with the document in the knowledge base 310 and used for filtering during retrieval operations. One or more of the metadata tags may be dynamic in that it may be updated over time as new documents are ingested or as the document or document corpus evolves. For example, temporal metadata may be updated to reflect a most recent document for a particular entity. As another example, entity metadata may be re-tagged based on changing references or newly identified entities.

The knowledge base 310 may be configured to prioritize the retrieval of the most recent document for a particular topic. For example, a selection mechanism may be employed to identify the document with the most recent data based on temporal metadata tags associated with the document.

The query processing module 320 processes user queries to facilitate retrieval. The query processing module 320 may receive user input and perform text preprocessing, entity recognition, metadata extraction, and query embedding. For example, the query processing module 320 may extract named entities, keywords, and metadata tags from the query. The extracted data may be used to refine retrieval operations and improve response relevance. The query processing module 320 may convert the query into a vector representation using a natural language processing (NLP) model and may pass the query vector to subsequent modules.

The entity disambiguation module 330 resolves ambiguous entity references within the query to ensure retrieval is aligned with the correct subject matter. The entity disambiguation module 330 may extract entities from the query, convert them into vector representations, and compare them against an entity knowledge base stored in a vector database. The entity disambiguation module 330 may identify the most relevant entity based on a similarity metric such as for example cosine similarity or Euclidean distance and may adjust the query vector and/or the entity metadata of the query vector accordingly before passing it to the retrieval module 340.

The retrieval module 340 retrieves documents from the knowledge base 310 based on the processed query. For example, the retrieval module 340 may receive a query vector from the query processing module 320 (or the entity disambiguation module 330, if applicable). The retrieval module 340 may compare the query vector to stored document embeddings within the knowledge base 310 and may identify the most relevant documents using vector similarity search techniques (e.g., cosine similarity, Euclidean distance). The retrieval module 340 may apply metadata filters (e.g., time constraints, content categories) to refine search results.

The retrieval module 340 may also apply metadata filters such as for example entity metadata filters and/or temporal metadata filters to refine the document search space before performing similarity matching. The entity metadata filters may restrict retrieval to documents that are semantically associated with the disambiguated entity identified by the entity disambiguation module 330. The temporal metadata filters may reduce the document corpus by filtering out documents that fall outside of a specified time range, ensuring the retrieval prioritizes the most recent and relevant context. By applying these filters before executing the vector similarity search, the retrieval module 340 improves retrieval efficiency and reduces processing overhead.

The ranking module 350 ranks retrieved documents to ensure the most relevant information is prioritized. The ranking module 350 may use LLM-based re-ranking models (e.g., transformer-based ranking) to reassess retrieved documents based on semantic relevance. The ranking module 350 may also apply heuristic-based scoring (e.g., recency, document quality, user-specific relevance) to determine the final ranking order before passing the top results to the response generation module 360.

The response generation module 360 receives the ranked documents and generates a context-aware response. The response generation module 360 may pass the retrieved documents, the original query, and any extracted metadata to an LLM (e.g., ChatGPT) to generate a natural language response. The LLM may be prompted to construct responses that are coherent, concise, and contextually accurate based on the top-ranked documents. The response generation module 360 may format the response in a structured manner before providing it as output, such as within a chat interface displayed on a user's device.

The orchestration layer 370 manages communication between modules, routing queries through processing, retrieval, ranking, and response generation. The orchestration layer 370 ensures that query refinement, entity disambiguation, and document ranking occur in a structured sequence to optimize response accuracy and efficiency.

By embedding documents into a vector database and leveraging metadata extraction, entity disambiguation, metadata filtering, and advanced ranking, the engine 300 enables faster, more precise document retrieval. The system improves response relevance by ensuring that retrieved content is aligned with the user's intent, reducing noise and enhancing accuracy. The use of metadata tagging during document ingestion further optimizes retrieval by allowing efficient filtering. Further, the ability to dynamically update metadata tags ensures that the system adapts to new documents, maintaining the relevance and accuracy of document retrieval over time.

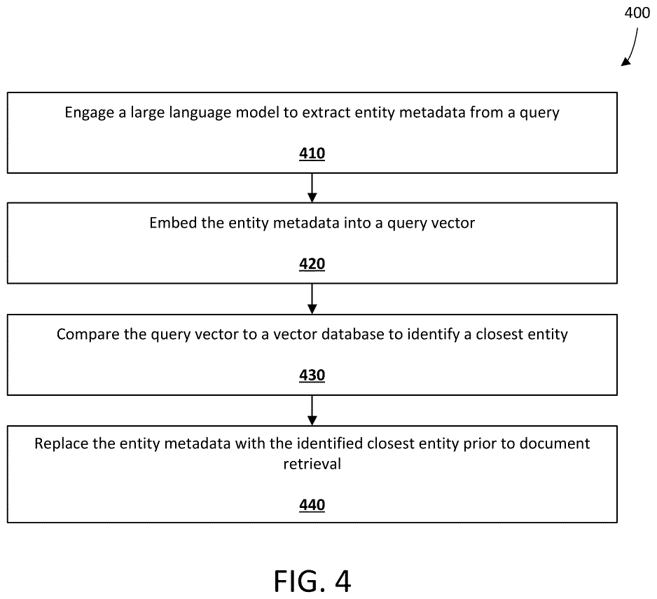

Reference is now made to FIG. 4, which illustrates an example method 400 for entity disambiguation. The method 400 may, in at least some implementations, be performed by one or both of a processor and a computer. For example, a memory may store instructions which, when executed, configure one or both of the processor and the computer to perform the method 400 or a portion thereof. At least some of the operations may be performed by one or more modules of the engine 300 described herein.

The method 400 includes engaging an LLM to extract entity metadata from a query (step 410).

The query may include a query input from a user on a computing device. For example, the query may be received via user input provided within an interface or chat interface displayed on the display screen of the computing device 110. The query may be received via a chatbot, web application, API request, etc. The query may include a text-based query.

An LLM is engaged to extract metadata from the query. The metadata may include one or more types of metadata such as for example entity metadata, intent metadata, temporal metadata, action metadata, data type metadata, domain-specific metadata, comparative metadata, geospatial metadata, uncertainty metadata, personalization metadata, and/or source expectation metadata.

Entity metadata may identify key entities present in the query. Examples include people, organizations, locations, etc.

Intent metadata may capture the underlying intent or purpose behind the query. For example, the intent metadata may identify whether the query is seeking facts, opinions, or actions.

Temporal metadata may extract time-based aspects of the query, including dates, durations, or references to the present, past, or future.

Action metadata may identify actions or operations implied by the query, such as for example retrieving, comparing, summarizing, or analyzing data.

Data type metadata may determine the expected format or type of the response. For example, the data type metadata may indicate that the response requires a name, a string, a number, a list, a date, a Boolean response, etc.

Domain-specific metadata may extract specialized knowledge related to the domain of the query (e.g. sports, finance, medicine) and the relevant contextual rules.

Comparative metadata may indicate whether the query involves a comparison between multiple entities or values.

Geospatial metadata may capture any geographical or location-based references in the query.

Uncertainty metadata may identify whether the query involves ambiguity, subjectivity, or requires disambiguation.

Personalization metadata may detect user-specific context that might refine the query.

Source expectation metadata may infer likely sources of the answer (e.g. structured databases, news articles, live data).

As one example, a query may be “Who is the current leading goal scorer in the NHL?” The LLM may extract entity metadata, identifying “NHL” and “goal scorer.” The LLM may also extract intent metadata, indicating that the query seeks information retrieval, as the user is requesting a specific fact about the NHL. Further, the LLM may extract temporal metadata, recognizing that the term “current” refers to the present time. The LLM may also extract action metadata, as the phrase “Who is” implies the retrieval of a name from structured data. Further, the LLM may extract data type metadata, indicating that the expected answer should include a person's name, likely represented as a string, and a numerical value corresponding to the goal count. The LLM may also extract domain-specific metadata, recognizing that the term “leading goal scorer” is a hockey-related statistic relevant within the NHL domain.

In addition, the LLM may extract comparative metadata, as the phrase “leading goal scorer” implies a ranking or comparison among players based on the number of goals scored. The LLM may extract geospatial metadata, as the NHL is a North American hockey league, which may limit the scope of relevant data to players within that league. The LLM may further extract uncertainty metadata, as the term “current” may require clarification—whether it refers to the ongoing season, the most recent game, or another specific timeframe. The LLM may also extract personalization metadata, which could refine the query based on user preferences, such as a history of interest in a particular team or player. Finally, the LLM may extract source expectation metadata, recognizing that an accurate response would likely require up-to-date information from authoritative sources, such as an official NHL statistics database or a trusted sports analytics provider.

As another example, a query may be “What is our current take on APPL”. The LLM may extract entity metadata, identifying “APPL”. The LLM may extract intent metadata, indicating that the query seeks an opinion or sentiment analysis. The LLM may extract temporal metadata, recognizing that the term “current” indicates a request for the most up-to-date perspective. The LLM may extract action metadata, as the phrase “What is our take” suggests retrieval of an opinion, analysis, or report. The LLM may extract data type metadata, indicating that the expected response is likely text-based such as a summary, sentiment score, or recommendation. The LLM may extract domain-specific metadata, recognizing that the query is related to finance/investment and may require market data, stock analysis, or internal reports. The LLM may extract personalization metadata as the word “our” suggests that the response should be tailored to the user's organization, team, or past analyses. The LLM may extract source expectation metadata, recognizing that the response may require information from financial reports, market trends, or internal investment search.

The method 400 includes embedding the entity metadata into a metadata vector (step 420).

The entity metadata extracted by the LLM is embedded into a metadata vector. For example, the entity metadata may be passed through an embedding model such as for example OpenAI, BERT, or Sentence Transformers.

As one example, the entity metadata may identify “APPL” and this entity metadata may be embedded into a metadata vector. The metadata vector may be used for disambiguation.

The method 400 includes comparing the metadata vector to a vector database to identify a closest entity (step 430).

To disambiguation the metadata vector, the metadata vector is compared to a vector database to identify a closest entity. The vector database may store or otherwise include a plurality of predefined metadata vectors that are associated with known entities. Put another way, each stored vector may be stored with a particular entity. For example, the vector database may store a plurality of predefined metadata vectors that are associated with known publicly traded companies or stock market tickers. As such, the entity metadata “APPL” may be disambiguated to “AAPL” which is a stock market ticker of a known publicly traded company.

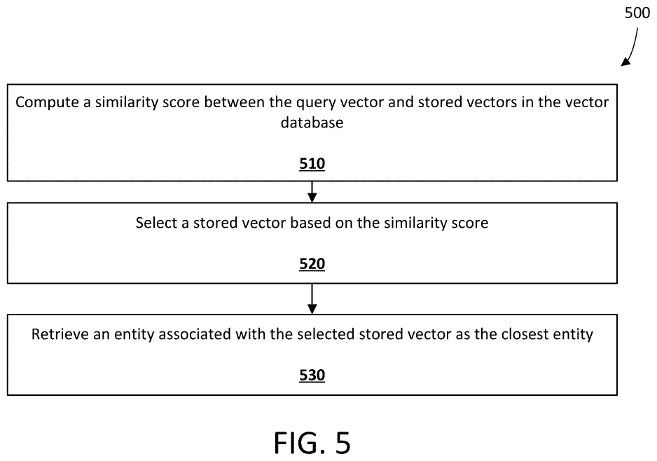

In one or more embodiments, when comparing the metadata vector to the vector database to identify the closest entity, a similarity search may be performed. Reference is now made to FIG. 5, which illustrates an example method 500 for performing a similarity search within a vector database. The method 500 may, in at least some implementations, be performed by one or both of a processor and a computer. For example, a memory may store instructions which, when executed, configure one or both of the processor and the computer to perform the method 500 or a portion thereof. At least some of the operations may be performed by one or more modules of the engine 300 described herein.

The method 500 includes computing a similarity score between the metadata vector and stored vectors in the vector database (step 510).

To determine the similarity score between the metadata vector and the stored vectors in the database, cosine similarity or Euclidean distance may be used.

Cosine similarity may measure the angular similarity between two vectors by computing the dot product of the metadata vector and a stored vector, divided by the product of their magnitudes. The result is a normalized similarity score ranging from −1 to 1, where higher values indicate greater similarity.

Euclidean distance may measure the straight-line distance between the metadata vector and the stored vectors in multidimensional space. Euclidean distance may be computed by subtracting corresponding vector components, squaring the differences, summing the squared values, and taking the square root of the result. A lower Euclidean distance indicates a higher degree of similarity.

The similarity score is used to rank the stored vectors in the database in order of relevance to the metadata vector.

The method 500 includes selecting a stored vector based on the similarity score (step 520).

A stored vector is selected based on the similarity score. For example, as mentioned, the similarity score may be used to rank the stored vectors in order of relevance to the metadata vector and such the highest ranked stored vector may be selected.

The method 500 includes retrieving an entity associated with the selected stored vector as the closest entity (step 530).

The entity associated with the selected stored vector is retrieved. For example, the selected stored vector may be stored in the vector database in association with the entity and as such the entity may be retrieved and identified as the closest entity.

Referring back to step 430 of the method 400, in one or more embodiments, when comparing the metadata vector to the vector database to identify the closest identity, an exact match search may be performed within the vector database and this may be done prior to performing the similarity search.

As one example of performing an exact match search, a lookup may be performed in the vector database using the metadata vector to determine if an exact match exists in the vector database. The lookup may determine that the metadata vector exactly matches a stored vector in the database and an entity associated with the stored vector may be retrieved and identified as the closest entity in manners similar to that described herein.

As another example, a query may be used to check the vector database for an exact match. The query may include, for example, a structured query language (SQL) query.

In one or more embodiments, it may be determined, based on the exact match search, that the metadata vector does not exactly match a stored vector in the vector database. For example, in response to performing the exact match search, an empty result set may be returned and this may indicate that the metadata vector does not exactly match any one of the stored vectors in the vector database. In response to determining that the metadata vector does not exactly match any one of the stored vectors in the vector database, a similarity search may be performed and this may be done in manners similar to that described herein with reference to the method 500.

By performing an exact match search prior to a similarity search, computational efficiency is enhanced as it is quickly determined whether the metadata vector exists, thereby avoiding unnecessary similarity computations. The exact match search may be performed and only if no exact match is found does the system proceed to a more computationally intensive similarity search, reducing the number of computer operations required and improving overall performance.

The method 400 includes replacing the entity metadata with the identified closest entity prior to document retrieval (step 440).

The identified closest entity is used to replace the entity metadata for the query and this is done prior to document retrieval. By performing entity disambiguation prior to document retrieval, the entity metadata is updated or replaced to ensure the correct entity is used to perform the document search. In these embodiments, the query itself is not modified but rather the entity metadata of the query.

Updating the entity metadata without changing or modifying the query itself ensures that the retrieval process is more precise, allowing the system to fetch the most relevant information based on the corrected or clarified entity metadata. This improves the quality of the response without requiring the user to rephrase or adjust the query. Put another way, updating the entity metadata does not change the semantic meaning of the query itself. Rather, updating the entity metadata refines the context in which the query is understood, improving the system's ability to retrieve the most relevant information, but keeping the original intent.

In one or more embodiments, the entity metadata associated with the query may be used to generate an entity metadata filter which may be applied to a vector database to identify a subset of vectors within the vector database. For example, as mentioned, the retrieval module 340 may apply metadata filters such as for example entity metadata filters to refine the document search space.

As mentioned, documents added to the knowledge base 310 may be automatically processed to generate metadata tags. The system may analyze the document content to extract metadata tags such as for example entity metadata tags and temporal metadata tags. The metadata tags may be stored in association with the document in the knowledge base 310 and used for filtering during retrieval operations.

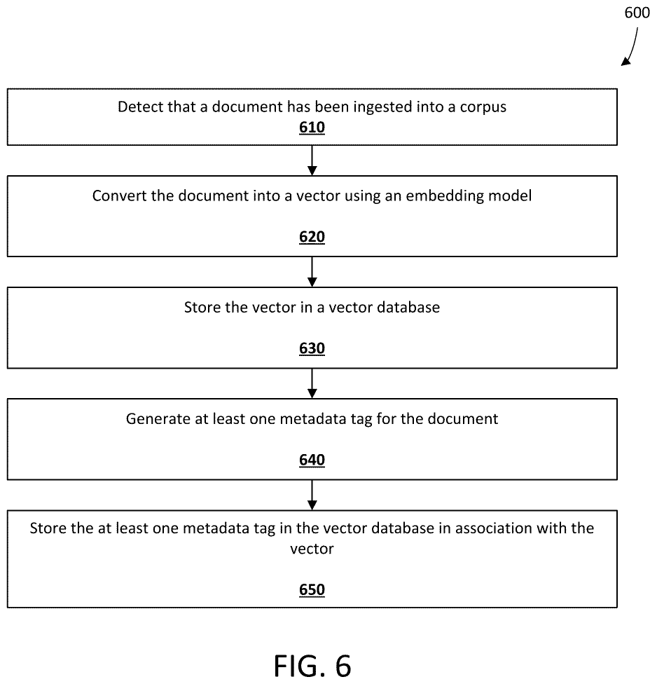

Reference is now made to FIG. 6, which illustrates an example method 600 of generating at least one metadata tag for a document ingested into a corpus. The method 600 may, in at least some implementations, be performed by one or both of a processor and a computer. For example, a memory may store instructions which, when executed, configure one or both of the processor and the computer to perform the method 600 or a portion thereof. At least some of the operations may be performed by one or more modules of the engine 300 described herein.

The method 600 includes detecting that a document has been ingested into a corpus (step 610).

In one or more embodiments, a data ingestion pipeline or input data stream may be monitored to identify a new document added to the corpus. The document may be ingested into the corpus through manual uploads, automated data synchronization, an API, etc. In one or more embodiments, a signal may be received indicating that the new document has been added to the corpus.

The method 600 includes converting the document into a vector using an embedding model (step 620).

Responsive to detecting that the document has been ingested into the corpus, an embedding model may be engaged to apply a machine learning-based transformation to encode the document's content into a numerical representation within a multi-dimensional vector space. The transformation may capture semantic meaning, contextual relationships, and key features of the document allowing it to be compared and retrieved based on similarity to other vectors. The embedding model may utilize deep learning such as for example through transformer-based encoders, word embeddings, or sentence embeddings to convert the document into the vector.

The method 600 includes storing the vector in the vector database (step 630).

The vector is stored in the vector database. The vector database may be optimized for efficient storage, retrieval, and similarity searches in accordance with embodiments described herein.

The method 600 includes generating at least one metadata tag for the document (step 640).

The at least one metadata tag may provide additional contextual information about the document. The at least one metadata tag may be derived from various sources such as for example document properties, extracted keywords, document classification, etc.

In one or more embodiments, the document may be analyzed using techniques such as for example natural language processing (NLP), rule-based heuristics, machine learning classifiers and this may be done using, for example, an LLM. The LLM may analyze the document's content and may extract meaningful metadata using NLP techniques.

As one example, an LLM may be engaged to extract metadata from the document. The metadata may include one or more types of metadata such as, for example, entity metadata, temporal metadata, domain-specific metadata, geospatial metadata, uncertainty metadata, document structure metadata, authorship metadata, source credibility metadata, summarization metadata, document type metadata, interlinking metadata, and/or accessibility metadata.

Entity metadata may identify key entities present in the document. Examples include people, organizations, locations, etc.

Temporal metadata may extract time-based aspects of the document, including timestamps, event durations, or references to historical and future events.

Domain-specific metadata may extract specialized knowledge related to the domain of the document (e.g., sports, finance, medicine) and relevant contextual rules.

Geospatial metadata may capture any geographical or location-based references in the document.

Uncertainty metadata may identify whether the document contains ambiguous, speculative, or contradictory information.

Document structure metadata may extract the structural components of the document, such as titles, headings, sections, paragraphs, tables, and lists, to assist with targeted retrieval of relevant passages.

Authorship metadata may capture information about the document's author(s), contributors, and affiliations, which may help assess credibility and authority.

Source credibility metadata may assess the reliability of the document based on factors such as publication source, peer review status, domain authority, and reputation.

Summarization metadata may generate a concise summary of the document's content to facilitate faster retrieval and relevance ranking.

Document type metadata may classify the document into categories such as news article, research paper, legal document, user-generated content, product review, etc., to improve relevance filtering.

Interlinking metadata may identify references, citations, hyperlinks, and cross-references to other documents, enabling better knowledge graph construction and retrieval connections.

Accessibility metadata may determine whether the document contains multimedia elements (images, charts, audio, video) and extract alternative representations such as captions or transcripts for accessibility and multimodal search.

The extracted metadata may be used to generate the at least one metadata tag for the document. The at least one metadata tag may include at least one of an entity metadata tag, a temporal metadata tag, a domain-specific metadata tag, a geospatial metadata tag, an uncertainty metadata tag, a document structure metadata tag, an authorship metadata tag, a source credibility metadata tag, a summarization metadata tag, a document type metadata tag, an interlinking metadata tag, and/or an accessibility metadata tag.

In one or more embodiments, the at least one metadata tag may be selected from a list of predefined metadata tags and this may be done to ensure that the documents within the corpus are only tagged using metadata tags that are known. For example, a list of predefined entity metadata tags may include entity metadata tags that are associated with known publicly traded companies or stock market tickers The use of predefined metadata tags may standardize document indexing and retrieval, may optimize search filtering, improve ranking and relevance by enforcing consistent metadata fields, and may increase performance in document retrieval.

The predefined metadata tags may be defined for each type of metadata or for only one type of metadata. For example, entity metadata tags may be predefined based on a list of known entities. As another example, temporal metadata tags may be predefined as “current” or “current as of <date>”.

The method 600 includes storing the at least one metadata tag in the vector database in association with the vector (step 650).

The at least one metadata tag is stored in the vector database in association with the vector for the document. The at least one metadata tag may be stored as a structured field such as for example a key-value pair. For example, the at least one metadata tag may be stored as {“entity”: “AAPL”).

In one or more embodiments, at least one of the metadata tags may be dynamic in that it may be updated over time as new documents are ingested or as the document or document corpus evolves. For example, a document may have a temporal metadata tag and at least one metadata tag. The temporal metadata tag may indicate whether the document is a most recent document for the at least one metadata tag or if the document is the latest document as of a particular date for the at least one metadata tag. The temporal metadata tag may be dynamic in that it may be updated when a new document has been added to the corpus that is associated with the same at least one metadata tag.

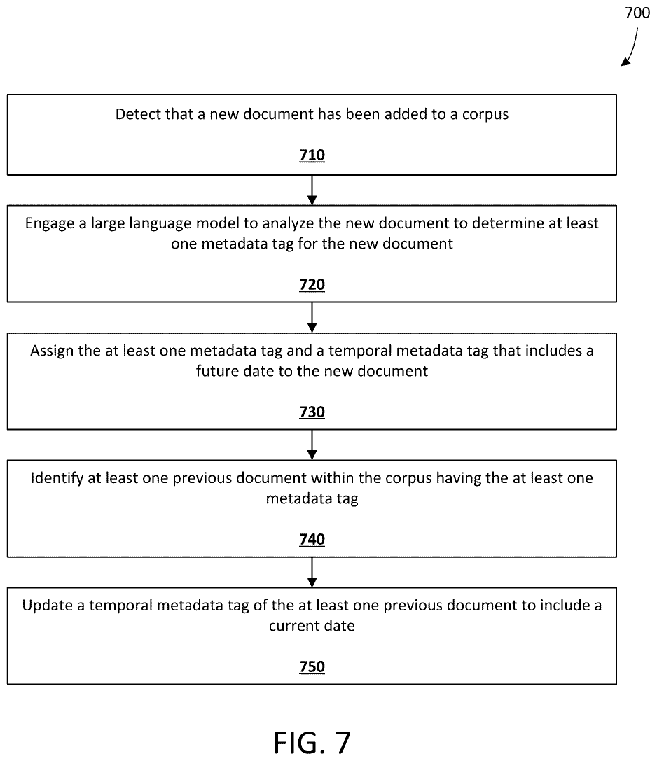

Reference is now made to FIG. 7, which illustrates an example method 700 for updating a dynamic metadata tag. The method 700 may, in at least some implementations, be performed by one or both of a processor and a computer. For example, a memory may store instructions which, when executed, configure one or both of the processor and the computer to perform the method 700 or a portion thereof. At least some of the operations may be performed by one or more modules of the engine 300 described herein.

The method 700 includes detecting that a new document has been added to a corpus (step 710).

The new document may be detected as being added to the corpus in manners similar to that described herein. For example, this step may be performed similar to the step 610 of the method 600. For example, a data ingestion pipeline or input data stream may be monitored to identify a new document added to the corpus. The document may be ingested into the corpus through manual uploads, automated data synchronization, an API, etc. As another example, a signal may be received indicating that the new document has been added to the corpus.

The new document may be converted into a vector using an embedding model and the vector may be stored in a vector database and this may be done in manners similar to that described herein such as for example as described with reference to steps 620 and 630 of the method 600.

The method 700 includes engaging an LLM to analyze the new document to determine at least one metadata tag for the new document (step 720).

The at least one metadata tag may be determined in manners similar to that described herein. For example, this step may be performed similar to the step 640 of the method 600.

The at least one metadata tag may include at least one of an entity metadata tag, a domain-specific metadata tag, a geospatial metadata tag, an uncertainty metadata tag, a document structure metadata tag, an authorship metadata tag, a source credibility metadata tag, a summarization metadata tag, a document type metadata tag, an interlinking metadata tag, or an accessibility metadata tag. In this example, the at least one metadata tag for the new document that is determined during the step 720 does not include a temporal metadata tag.

As one example, the at least one metadata tag may include an entity metadata tag. For example, the document may be associated with a particular stock ticker such as for example “AAPL” and as such the entity metadata tag may include “AAPL”.

The method 700 includes assigning the at least one metadata tag and a temporal metadata tag that includes a future date to the new document (step 730).

The at least one metadata tag is assigned to the new document. For example, an entity metadata tag may be determined for the new document during the step 720 and as such the new document may be assigned the entity metadata tag.

The temporal metadata tag may indicate whether the document is a most recent document for the at least one metadata tag or if the document is the latest document as of a particular date for the at least one metadata tag. For example, the temporal metadata tag may be used to indicate that the new document contains the most recent data for a topic or entity associated with the at least one metadata tag.

To indicate that the document is a most recent document for the at least one metadata tag, the temporal metadata tag includes a future date.

The future date may be predefined as a far-future placeholder date or may be calculated based on a predefined calculation. For example, the predefined far-future placeholder date may be Jan. 1, 3000, and as such the temporal metadata tag may be assigned as Jan. 1, 3000. As another example, the predefined calculation may define that the future date is to be 100 years past a current date. As such, if the current date is Jan. 1, 2025, the future date may be calculated to be Jan. 1, 2125.

Assigning a future date to the most recent document improves efficiency in retrieving the latest document. For example, when querying for the most recent document based on the at least one metadata tag, the system can simply look for the document with the latest temporal metadata tag. By using a predefined far-future placeholder date, the system avoids complex sorting or filtering operations and can instantly retrieve the most recent document without additional computations.

Once the at least one metadata tag and the temporal metadata tag have been assigned to the new document, the at least one metadata tag and the temporal metadata tag may be stored in the vector database in association with the vector for the new document.

The method 700 includes identifying at least one previous document within the corpus having the at least one metadata tag (step 740).

At least one previous document within the corpus is identified that has the at least one metadata tag.

As one example, the vector database may be searched using the at least one metadata tag and the at least one previous document may be identified based on the search.

As another example, the vector database may be searched using the at least one metadata tag and the temporal metadata tag. In this example, the temporal metadata tag, such as for example the predefined far-future placeholder date, may be used to identify the document that was previously the most recent for the at least one metadata tag.

The method 700 includes updating a temporal metadata tag of the at least one previous document to include a current date (step 750).

The temporal metadata tag of the at least one previous document may be modified from the future date to the current date. Specifically, the temporal metadata tag of the at least one previous document is updated to include the current date. As such, the at least one previous document is no longer tagged with the predefined far-future placeholder date. Rather, the temporal metadata tag of the at least one previous document is updated to reflect that it was the most recent document as of the current date.

Updating the temporal metadata tag of the at least one previous document to the current date ensures that the at least one previous document remains accessible with the respective “as of” date. This preserves historical accuracy while maintaining efficient access to the most up-to-date information.

As one example, a query may be received that asks “Who was the leading scorer in the NHL last month?”. A temporal metadata tag such as “as of Mar. 31, 2025” may be generated and used to retrieve one or more documents with a matching temporal metadata tag. These documents may then be used to generate a response to the query.

As another example, a query may be received that asks “Who is the current leading scorer in the NHL?”. A temporal metadata tag such as “current” may be generated and used to retrieve one or more documents with the latest temporal metadata. The system may identify one or more documents tagged with the most recent date or a predefined far-future placeholder date, which can then be used to generate the response.

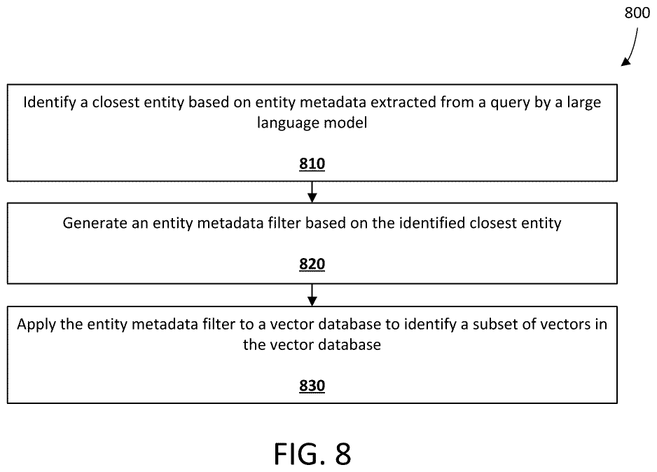

The metadata filters described herein may be used to identify a subset of vectors within the vector database prior to document retrieval. Reference is now made to FIG. 8, which illustrates an example method 800 for applying an entity metadata filter. The method 800 may, in at least some implementations, be performed by one or both of a processor and a computer. For example, a memory may store instructions which, when executed, configure one or both of the processor and the computer to perform the method 800 or a portion thereof. At least some of the operations may be performed by one or more modules of the engine 300 described herein.

The method 800 includes identifying a closest entity based on entity metadata extracted from a query by an LLM (step 810).

The closest entity may be identified in manners similar to that described herein with reference to the method 400. For example, entity metadata may be extracted from the query, embedded into a metadata vector, and compared against a database containing predefined metadata vectors associated with known entities. By performing entity disambiguation, the extracted metadata may be matched to the closest known entity, ensuring that only recognized or known entities are used for metadata filtering.

It will be appreciated that the entity metadata of the query may be replaced with the identified closest entity as described above.

The method 800 includes generating an entity metadata filter based on the identified closest entity (step 820).

An entity metadata filter is generated based on the identified closest entity. For example, the entity metadata filter may be generated based on a name of the entity. As another example, the entity metadata filter may be retrieved from the vector database based on the identified closest entity.

As one example, a query may be “Who is the current leading goal scorer in the NHGL?” and the extracted entity metadata may include “NHGL”. After entity disambiguation, the closest entity may be identified as the “NHL” and as such an entity metadata filter may be generated and may include “NHL”.

As another example, a query may be “What is our current position on APPL” and the extracted entity metadata may include “APPL”. After entity disambiguation, the closest entity may be identified as “AAPL”. An entity metadata filter may be retrieved from the database and may include “APPLE INC.” and/or “AAPL”.

The method 800 includes applying the entity metadata filter to a vector database to identify a subset of vectors in the vector database (step 830).

The vector database stores a plurality of vectors, where each vector may be associated with a document in a corpus. At least one metadata tag may be stored in association with each vector in the vector database as described herein, where the at least one metadata tag may include an entity metadata tag. As such, applying the entity metadata filter to the vector database may identify a subset of vectors having the entity metadata tag.

As one example, applying an entity metadata filter “NHL” may identify a subset of vectors having an entity metadata tag “NHL” within the vector database.

It will be appreciated that metadata filters may be generated based on other types of metadata. For example, another metadata filter may be generated based on another type of metadata such as for example temporal metadata. Specifically, the temporal metadata of the query may include “current” and as such another metadata may be generated and may include “current”. The at least one other metadata filter may be applied to the vectors in the vector database to identify a subset of vectors in the vector database in manners similar to that described in. Alternatively, the at least one other metadata filter may be applied to the subset of vectors (such as those identified during the step 830) to identify a smaller subset of vectors in the vector database.

In the example where the entity metadata filter “NHL” is applied to the vector database to identify a subset of vectors in the vector database having an entity metadata tag of “NHL”, a temporal metadata filter “current” may be applied to the subset of vectors to identify a smaller subset of vectors.

Applying one or more metadata filters prior to document retrieval improves efficiency by reducing the search space and ensuring relevance. For example, the entity metadata filter enables the system to retrieve only documents associated with a specific entity, thereby reducing processing overhead and improving response accuracy. The temporal metadata filter ensures that the system retrieves only documents tagged with the most relevant time stamps. By combining entity and temporal metadata filters, the system optimizes document retrieval, minimizes computational costs, and enhances the accuracy of the generated response.

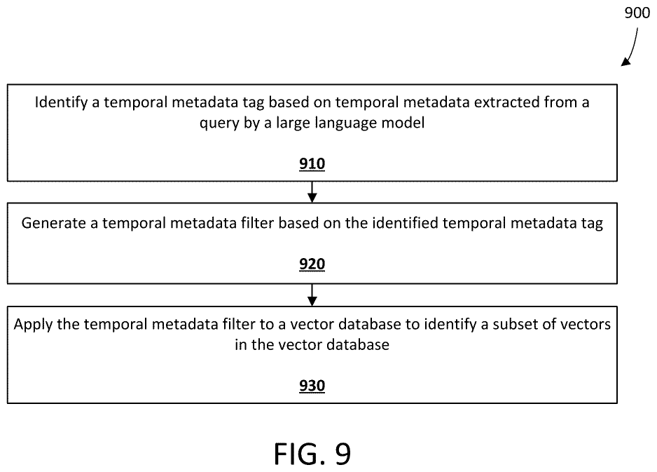

In one or more embodiments, temporal metadata filters described herein may be used to identify a subset of vectors within the vector database prior to document retrieval. Reference is now made to FIG. 9, which illustrates an example method 900 for applying a temporal metadata filter. The method 900 may, in at least some implementations, be performed by one or both of a processor and a computer. For example, a memory may store instructions which, when executed, configure one or both of the processor and the computer to perform the method 900 or a portion thereof. At least some of the operations may be performed by one or more modules of the engine 300 described herein.

The method 900 includes identifying a temporal metadata tag based on temporal metadata extracted from a query by an LLM (step 910).

The temporal metadata tag may be identified in manners similar to that described herein. For example, the LLM may analyze a query to extract temporal metadata from the query. The temporal metadata may include time-based aspects of the query, including dates, durations, or references to the present, past, or future.

As one example, a query may be “Who is the current leading goal scorer in the NHL?” The LLM may extract temporal metadata, recognizing that the term “current” refers to the present time.

As another example, a query may be “What was our take on AAPL in March 2024?” The LLM may extract temporal metadata, recognizing that the “our take” and “in March 2024” refers to “current as of March 2024”.

The method 900 includes generating a temporal metadata filter based on the identified temporal metadata tag (step 920).

A temporal metadata filter is generated based on the temporal metadata tag. For example, the temporal metadata filter may be generated as “current”. As another example, the temporal metadata filter may be generated as “current as of March 2024”.

The method 900 included applying the temporal metadata filter to a vector database to identify a subset of vectors in the vector database (step 930).

The vector database stores a plurality of vectors, where each vector may be associated with a document in a corpus. At least one metadata tag may be stored in association with each vector in the vector database as described herein, where the at least one metadata tag may include a temporal metadata tag. As such, applying the temporal metadata filter to the vector database may identify a subset of vectors having the temporal metadata tag.

As mentioned, documents within the corpus may include a temporal metadata tag that indicates whether the document is a most recent document or if the document is the latest document as of a particular date. For example, the temporal metadata tag may be used to indicate that the new document contains the most recent data for a topic or entity.

As described herein, to indicate that the document is a most recent document, the temporal metadata tag includes a future date, where the future date may be predefined as a far-future placeholder date.

As such, the temporal metadata filter may be applied to the vector database to identify a subset of vectors within the vector database based on the temporal metadata. For example, applying the temporal metadata filter of “current” will identify a subset of vectors within the vector database that have a temporal metadata tag that indicates that the corresponding document is a most recent document. As another example, applying the temporal metadata filter of “current as of March 2024” will identify a subset of vectors within the vector database that have a temporal metadata tag that indicates that the corresponding document was current as of March 2024.

As described herein, the temporal metadata tags of the document may be dynamic in that they may be updated in real-time as the document corpus evolves. By applying temporal metadata filters based on temporal metadata extracted from a query, only the most recent or most relevant documents may be identified prior to document retrieval.

Further, the temporal metadata filters may reduce the document corpus by filtering out documents that fall outside of a specified time range, ensuring the retrieval prioritizes the most recent or most relevant. By applying these filters before executing the vector similarity search, the retrieval module 340 improves retrieval efficiency and reduces processing overhead.

It will be appreciated that metadata filters may be generated based on other types of metadata. For example, another metadata filter may be generated based on another type of metadata such as for example entity metadata. The at least one other metadata filter may be applied to the vectors in the database to identify a subset of vectors in the database in manners similar to that described in. Alternatively, the at least one other metadata filter may be applied to the subset of vectors (such as those identified during the step 930) to identify a smaller subset of vectors in the vector database.

In the example where the temporal metadata filter “current” is applied to the vector database to identify a subset of vectors having a temporal metadata tag of “current”, an entity metadata filter “NHL” may be applied to the subset of vectors to identify a smaller subset of vectors.

Applying one or more metadata filters prior to document retrieval improves efficiency by reducing the search space and ensuring relevance. For example, the entity metadata filter enables the system to retrieve only documents that are current and associated with a specific entity, thereby reducing processing overhead and improving response accuracy. By combining entity and temporal metadata filters, the system optimizes document retrieval, minimizes computational costs, and enhances the accuracy of the generated response.

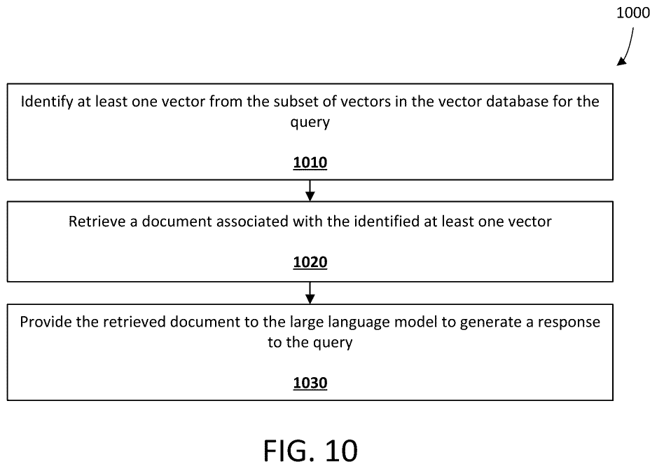

Reference is now made to FIG. 10, which illustrates an example method 1000 for document retrieval. The method 1000 may, in at least some implementations, be performed by one or both of a processor and a computer. For example, a memory may store instructions which, when executed, configure one or both of the processor and the computer to perform the method 1000 or a portion thereof. At least some of the operations may be performed by one or more modules of the engine 300 described herein. In one or more embodiments, the method 1000 may be performed subsequent to applying one or more metadata filters, such as in step 830 of the method 800 and/or step 930 of the method 900, to identify a subset of vectors within a vector database.

The method 1000 includes identifying at least one vector from the subsequent vectors in the vector database for the query (step 1010).

In one or more embodiments, the subset of vectors may correspond to vectors previously identified through metadata filtering based on temporal and/or entity metadata as described herein.

In one or more embodiments, a similarity search may be performed over the subset of vectors using, for example, a query embedding derived from the input query. The similarity search may include computing a distance or similarity metric (e.g., cosine similarity) between the query embedding and each vector in the subset. The result of the similarity search may identify at least one vector whose corresponding embedding exhibits the highest degree of semantic similarity to the query embedding.

As described herein, the subset of vectors may have already been reduced in size based on temporal relevance, entity match, or other metadata attributes. Identifying at least one vector from this refined subset improves retrieval efficiency and enables high-relevance document retrieval, even when operating over large-scale vector databases.

The method 1000 includes retrieving a document associated with the identified at least one vector (step 1020).

As mentioned, each vector stored in the vector database may be associated with a document in a corpus. Upon identification of at least one relevant vector as described in step 1010, a corresponding document may be retrieved from storage. In some embodiments, a pointer, identifier, or metadata field associated with the vector may reference the document, allowing for efficient dereferencing and access. The retrieved document may include textual data, structured data, or multimodal content previously encoded into vector representations for similarity-based retrieval.

The method 1000 includes providing the retrieved document to the LLM to generate a response to the query (step 1030).

In some embodiments, the retrieved document may be passed as context to an LLM for further processing. The LLM may be configured to consume the input query along with the retrieved document and generate a natural language response based on the semantic relationship between the query and the document content. For example, the LLM may extract relevant information, summarize content, or answer user queries using the document as an authoritative source of truth.

In one or more embodiments, providing the document to the LLM enables grounded response generation, where outputs are based on verifiable document content rather than model priors alone. This step may further improve accuracy, interpretability, and consistency of responses, particularly in domains requiring high factual reliability.

As described herein, method 1000 may be executed as part of a multi-stage retrieval and generation pipeline, wherein documents retrieved through metadata filtering and vector similarity search are used to enhance the performance of a downstream LLM. Execution of the method 1000 following application of one or more metadata filters enables efficient, contextually relevant, and temporally grounded document retrieval and response generation.

In one or more embodiments, metadata filtering in combination with temporal proximity detection may be used and may enable efficient and contextually aligned document selection or retrieval for response generation. For example, metadata filters may be applied to identify a subset of vectors in a vector database. Temporal proximity detection may be used to identify vectors that are temporally closest to temporal metadata extracted from the query. From this subset of vectors, the system may select a document associated with the most recent vector for direct response generation and may select the documents associated with the top k vectors for summarization. This may improve response relevance and may reduce computational overhead.

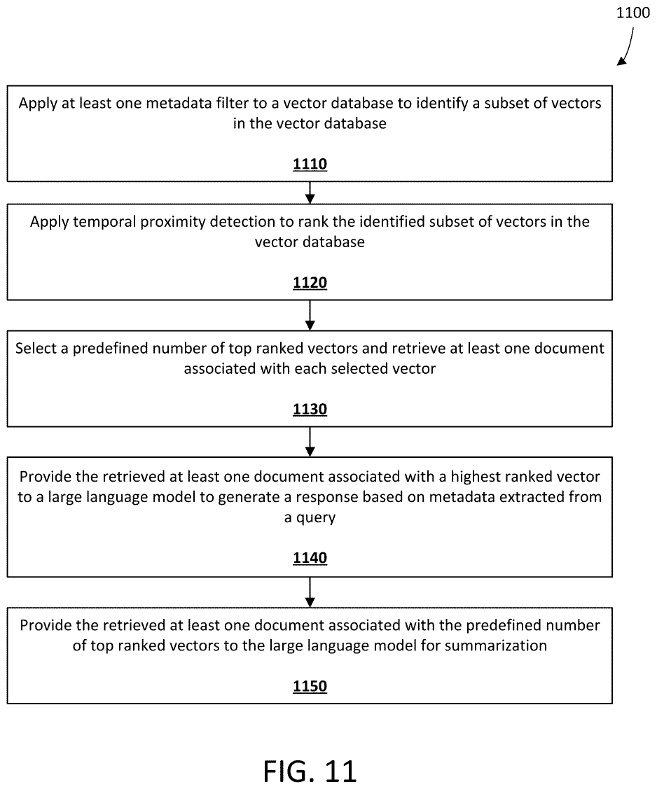

Reference is now made to FIG. 11, which illustrates an example method 1000 for providing documents to an LLM. The method 1100 may, in at least some implementations, be performed by one or both of a processor and a computer. For example, a memory may store instructions which, when executed, configure one or both of the processor and the computer to perform the method 1000 or a portion thereof. At least some of the operations may be performed by one or more modules of the engine 300 described herein.

The method 1100 includes applying at least one metadata filter to a vector database to identify a subset of vectors in the vector database (step 1110).

The vector database stores a plurality of vectors, where each vector may be associated with a document in a corpus. At least one metadata tag may be stored in association with each vector in the vector database as described herein, where the at least one metadata tag may include an entity metadata tag.

The at least one metadata filter may be generated based on metadata extracted from the query. For example, an LLM may analyze the query to identify relevant metadata such as for example entity metadata. The identified metadata may be used to generate the at least one metadata filter.

In one or more embodiments, at least one metadata tag may be identified based on the metadata extracted from the query by the LLM. For example, the metadata extracted from the query may be compared to a list of predefined metadata tags and the closest metadata tag may be identified, in manners similar to that described herein. In one or more embodiments, the metadata tags may include temporal metadata tags to identify the most relevant documents based on time sensitivity. The at least one metadata filter may be generated based on the at least one metadata tag.

Applying the at least one metadata filter to the vector database may identify a subset of vectors that include metadata tags that match the at least one metadata filter. For example, the subset may include only those vectors associated with a particular entity.

It will be appreciated that more than one metadata filter may be applied to refine the subset of vectors identified in the vector database. For example, an entity metadata filter may be first applied to select vectors relevant to a particular entity, followed by a temporal metadata filter that narrows the results based on a time frame specified in the query. The sequential application of metadata filters may allow for a more precise subset of vectors to be identified before temporal proximity detection is applied.

The method 1100 includes applying temporal proximity detection to rank the identified subset of vectors in the vector database (step 1120).

Temporal proximity detection may be applied to rank the subset of vectors based on how temporally close each vector's associated metadata is to a reference time, such as for example a time of the query or based on temporal metadata extracted from the query.

As one example, the temporal metadata extracted from the query may include a time of “March 2024” and as such vectors having temporal metadata tags “current as of March 2024” may be ranked highest. As described herein, temporal metadata tags that include a far-future timestamp may be automatically prioritized when the temporal metadata extracted from the query includes “current”. A scoring function may be used to compute temporal distance, where smaller differences between the temporal metadata tags of the vectors and the temporal metadata extracted from the query result in higher ranks.

The ranking may be determined using one or more scoring functions that compute a temporal distance between the temporal metadata extracted from the query and the temporal metadata tag associated with the vectors.

The method 1100 includes selecting a predefined number of top ranked vectors and retrieving at least one document associated with each selected vector (step 1130).

In one or more embodiments, the predefined number may be a configurable parameter such as for example the top k vectors. The predefined number may be, for example, the top 3 vectors.

Each selected vector may be associated with a document stored in a document corpus and as such the document associated with each selected vector is retrieved. This may include accessing a document store or an index that maps the vectors to their corresponding documents.

The method 1100 includes providing the retrieved at least one document associated with a highest ranked vector to an LLM to generate a response based on metadata extracted from a query (step 1140).

In one or more embodiments, the at least one document associated with the highest ranked vector may include a most recent document and/or a most relevant document. For example, the most recent document tagged with an entity metadata tag may be identified.

In one or more embodiments, the at least one document associated with the highest ranked vector may include a most recent value associated with the metadata extracted from the query. For example, the query may ask for a current or recent price target for a particular stock and as such the at least one document may include a most recent price target for the particular stock.

The LLM may generate a targeted response based on the content of the highest ranked document, where the document is selected for being the most temporally relevant for the query. The metadata extracted from the query may guide the response generation, ensuring alignment with the temporal intent of the query, such as reflecting the most up-to-date value associated with the metadata extracted from the query.

As one example, the query may include “What is our current take on AAPL.” As such, the LLM may extract “AAPL” as the entity metadata and may select the most recent document containing a price target for AAPL stock for the response. In this example, the “current” temporal metadata extracted from the query may be used to ensure that the most recent document with the updated price target for AAPL is selected, improving the accuracy of the response.

The method 1100 includes providing the retrieved at least one document associated with the predefined number of top ranked vectors to the LLM for summarization (step 1150).

The at least one document associated with the top ranked vectors may include data relevant to the metadata extracted from the query.

The LLM may analyze the top k retrieved documents to generate a summarization that reflects broader temporal context. For example, the summarization may reflect a trend over a recent time window, such as a trend in the technology stock sector. In the example where the query includes “What is our current take on AAPL,”, the top 3 recent documents may be retrieved for summarization, potentially including documents related to AAPL or related to broader trends in the technology stock market. This may allow the LLM to provide a more comprehensive summary, integrating both specific insights for AAPL and contextual data on overall trends within the technology sector.

By leveraging metadata filtering, temporal metadata tagging, and temporal proximity detection, the system enables efficient document retrieval that balances both recency and relevance for response generation and summarization.

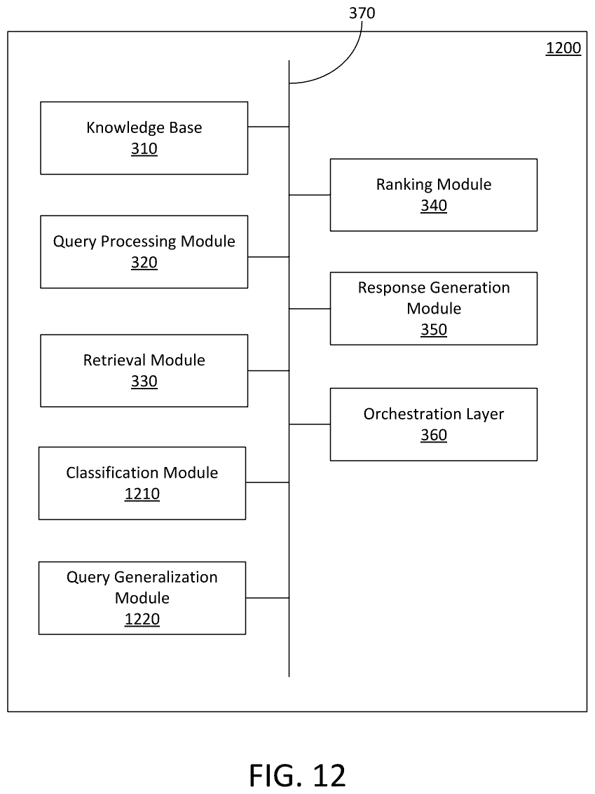

Turning now to FIG. 12, another engine 1200 is shown. The engine 1200 is generally similar to the engine 300 described herein with the following exceptions. In this embodiment, the engine 1200 includes a classification module 1210 and a query generalization module 1220.

The classification module 1210 may use machine learning models, rule-based systems, or fine-tuned language models to classify a query into a particular category. The category may be used to filter the document corpus, ensuring that only documents relevant to the classification are retrieved. For example, if a query is classified as a “holdings” question, the classification module 1210 may restrict retrieval to documents tagged with holding-related metadata. In addition, the classification module 1210 may be continuously updated and retrained with new data, allowing the system to adapt to emerging query patterns and evolving metadata, ensuring that the classification module 1210 stays current with new types of queries and changes to the underlying data.

The classification module 1210 may further refine retrieval by ensuring that only documents matching the query's classification category are considered. By integrating classification-based filtering before retrieval, the system improves precision and reduces noise in search results. Further, the system may periodically or continuously retrain the classification module 1210 using updated query logs, new user inputs, or feedback from the response generation process. In this manner, the system may adapt to shifts in query trends and the emergence of new categories, even as the types of queries evolve over time.

The query generalization module 1220 processes incoming queries to facilitate structured data retrieval. The query generalization module 1220 modifies an input query by replacing at least one entity with a generic placeholder. The modified query is then embedded into a vector representation and used to perform a similarity search against a database of pre-existing generified queries.

As will be described, if a similar generified query is identified within the database, the corresponding structured query language (SQL) query associated with the generified query is extracted. The SQL query is then provided to the response generation module 360, which may use an LLM to execute or refine the SQL query, generate a response based on the retrieved data, and format the response for output.

As one example, if a query includes “How many shares of AAPL does BlackRock hold?”, the query generalization module 1220 may replace “AAPL” with a generic placeholder (e.g. <TICKER>) and “BlackRock” with a generic placeholder (e.g. <INVESTOR>). A similarity search is then performed to identify at least one similar query such as “How many <TICKER> shares does <INVESTOR> currently hold?”, “How many <TICKER> shares has <INVESTOR> sold this quarter?” and “How many <TICKER> shares did <INVESTOR> hold last quarter?” The associated SQL queries are then retrieved and executed using the original query's entity values. The SQL result is provided to the LLM to generate a response.

The query generalization module 1220 ensures structured data retrieval and enhances response accuracy.

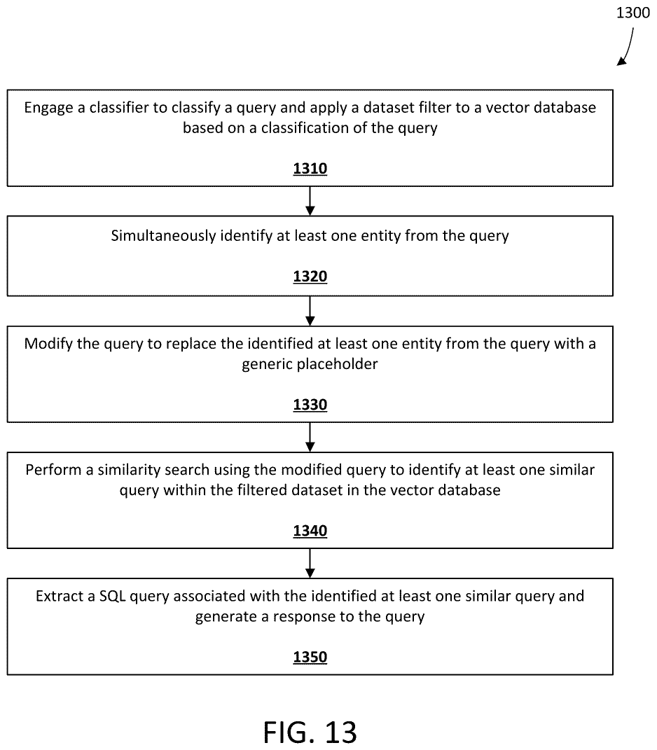

Reference is now made to FIG. 13, which illustrates an example method 1300 for extracting an SQL query. The method 1300 may, in at least some implementations, be performed by one or both of a processor and a computer. For example, a memory may store instructions which, when executed, configure one or both of the processor and the computer to perform the method 1300 or a portion thereof. At least some of the operations may be performed by one or more modules of the engine 1200 described herein.

The method 1300 includes engaging a classifier to classify a query and apply a dataset filter to a vector database based on a classification of the query (step 1310).

The vector database may store a plurality of vectors, where each vector may include an embedded query that is stored in association with a dataset tag and an SQL query. The embedded query may include a pre-existing generified query.

The classifier may include the classification module 1210. As described herein, the classification module 1210 may utilize machine learning models, rule-based systems, or fine-tuned language models to classify the query into a relevant category. The relevant category may be one of a number of predefined categories. For example, the classifier may assess the query's context, such as whether it relates to a financial report, a holdings question, or a general stock query.

In one or more embodiments, once the query has been classified, a dataset filter may be applied to a vector database to identify a subset of vectors within the vector database that include the dataset tag. For example, the query may be classified as a holdings question and as such only documents having the dataset tag “holdings” may be identified.

Upon classification, the dataset filter ensures that only vectors within the vector database are identified, filtering out irrelevant vectors to enhance precision. Put another way, the dataset filter is applied to identify a subset of vectors within the vector database.

The method 1300 includes simultaneously identifying at least one entity from the query (step 1320).

Identifying the at least one entity from the query may be performed in parallel with, or concurrently with, the query classification performed in the step 1320.

The at least one entity may be identified in manners similar to that described herein. For example, the query may be analyzed to extract entity metadata therefrom and the entity may be identified based on the entity metadata. In one or more embodiments, to identify the entity based on the entity metadata, a predefined list of entities may be consulted and the entity metadata may be identified based on a closest similarity search to the predefined list of entities.

In one or more embodiments, a disambiguation engine may be engaged to identify the at least one entity from the query. For example, the entity disambiguation module 330 described herein may be engaged and may perform one or more steps of the method 400 described herein to identify the at least one entity.

The at least one entity may include more than one entity. For example, the entity metadata may identify two separate entities.

As one example of identifying at least one entity, which may utilize the disambiguation engine, a query may include “How many shares of APPL does BlackRock hold?”. After disambiguation, the at least one entity may be identified as “AAPL” and “BlackRock”.

The method 1300 includes modifying the query to replace the identified at least one entity from the query with a generic placeholder (step 1330).

As mentioned, queries may be processed to facilitate structured data retrieval and this may be done using the query generalization module 1220. For example, the query generalization module 1220 may modify an input query by replacing the identified at least one entity with a generic placeholder.

In one or more embodiments, the generic placeholder may be generated by the LLM. For example, the entity “AAPL” may be provided to the LLM for generification and the LLM may generate the generic placeholder “TICKER” by determining that “AAPL” refers to a stock ticker.

In one or more embodiments, the generic placeholder may be generated by consulting a database. For example, the predefined list of entities may include a generic placeholder, a tag, or an entity type field that may be used to generate the generic placeholder. For example, the entity “AAPL” may be stored in the database in association with a tag “TICKER” and as such the generic placeholder may be generated based on the tag.

As one example, the query “How many shares of AAPL does BlackRock hold?” may be modified to “How many shares of <TICKER> does <INVESTOR> hold?”.

The method 1300 includes performing a similarity search using the modified query to identify at least one similar query within the filtered dataset in the vector database (step 1340).

As mentioned, upon classification, the dataset filter is applied to identify a subset of vectors within the vector database that satisfy the classification. A similarity search is performed on the subset of vectors within the vector dataset.

To perform the similarity search, the modified query may be embedded into a vector representation or query vector. A similarity search may then be performed and this may be done in manners similar to that described herein with reference to the method 500. For example, a similarity score may be computed between the query vector and stored vectors in the vector database.

To determine the similarity score between the metadata vector and the stored vectors in the database, cosine similarity or Euclidean distance may be used.

Cosine similarity may measure the angular similarity between two vectors by computing the dot product of the metadata vector and a stored vector, divided by the product of their magnitudes. The result is a normalized similarity score ranging from −1 to 1, where higher values indicate greater similarity.

Euclidean distance may measure the straight-line distance between the metadata vector and the stored vectors in multidimensional space. Euclidean distance may be computed by subtracting corresponding vector components, squaring the differences, summing the squared values, and taking the square root of the result. A lower Euclidean distance indicates a higher degree of similarity.

The similarity score is used to rank the stored vectors in the database in order of relevance to the query vector.

At least one stored vector is selected based on the similarity score. For example, as mentioned, the similarity score may be used to rank the stored vectors in order of relevance to the query vector and such the top k ranked vectors may be selected.

As mentioned, each vector in the vector database includes an embedded query where the embedded query may include a pre-existing generified query. As such, the top k pre-existing generified queries may be identified as being the at least one similar query within the filtered dataset in the vector database.

The at least one similar query may include a predefined number of similar queries, such as the pre-existing generified queries associated with the top k ranked vectors.

The method 1300 includes extracting a Structured Query Language (SQL) query associated with the identified at least one similar query and providing the SQL to an LLM to generate a response to the query (step 1350).

As mentioned, each vector in the vector database includes an embedded query and is stored in association with an SQL query. As such, the SQL query associated with the at least one similar query is extracted. The SQL query is then provided to the LLM to generate a response to the query.

In one or more embodiments, the query, the at least one similar query and the SQL query associated with the at least one similar query may be provided to the LLM to generate a response to the query. The response may be formatted accordingly for output, addressing the original query with the relevant structured data.

By extracting the SQL query associated with a generified query, the system can directly execute database queries, bypassing the need for complex query rewriting. This improves performance and ensures that responses are generated quickly and efficiently. Further, the method is rooted in computer technology and reflects a specific implementation of query transformation and execution that enhances structured data retrieval.

It will be appreciated that the query classification (step 1310) and the query generification process (steps 1320 and 1330) are performed in parallel, allowing both tasks to proceed independently, thereby optimizing the system's efficiency in processing queries. This parallelization represents a practical application of distributed processing to accelerate response generation.

As will be appreciated, the query generalization module enables the system to replace specific entities with generic placeholders, facilitating query reusability across different contests. The transformation of query structured into a generalized format enables the system to handle diverse inputs without relying on hard-coded rules or manual intervention. By generalizing queries, the system applies a specific computer-based solution to improve flexibility, scalability, and automation in structured data environments.

By performing a similarity search on the modified query against pre-existing generified queries, fast identification of similar queries within the dataset is enabled. This reduces computational overhead for processing new, previously unseen queries, as the system leverages existing patterns to find relevant SQL queries. The similarity-based retrieval, performed in a vector space, provides a technological solution by improving the matching process in a machine-interpretable embedding space. This accelerates the query preprocessing pipeline and ensures responses are generated faster and more efficiently.

Further, the integration of SQL queries ensures that responses are not only relevant but also based on accurate and structured data. By mapping the generified query to an SQL query, the system directly retrieves the data needed for a response ensuring that the response generation process is grounded in the most current and structured data available.

Through use of the generic placeholders and similarity searches, the system is highly scalable. As the system encounters more queries, the system may continuously expand the database with new generified queries without requiring manual intervention.

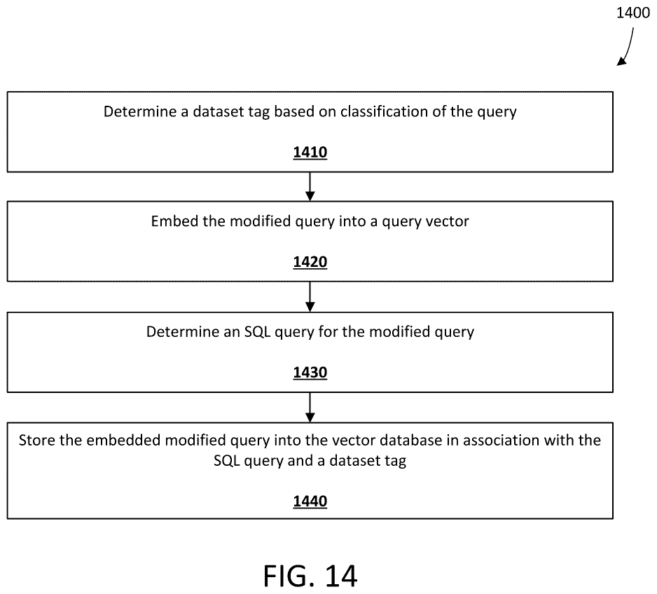

Reference is now made to FIG. 14, which illustrates an example method 1400 for adding a generified query to a database. The method 1400 may, in at least some implementations, be performed by one or both of a processor and a computer. For example, a memory may store instructions which, when executed, configure one or both of the processor and the computer to perform the method 1400 or a portion thereof. At least some of the operations may be performed by one or more modules of the engine 1200 described herein.

The method 1400 may be performed in response to completion of the method 1300 and may utilize data generated therefrom.

The method 1400 includes determining a dataset tag based on the classification of the query (step 1410).

The dataset tag may be determined based on the classification of the query determined during the step 1310 of the method 1300. For example, the query may be classified as a holdings query and as such the dataset tag “holdings” may be determined.

The method 1400 includes embedding the modified query into a query vector (step 1420).

The modified query, generated during the step 1330 of the method 1300, may be embedded into a query vector. In one or more embodiments, the query vector generated from the modified query during the step 1340 of the method 1300 may be obtained.

The method 1400 includes determining an SQL query for the modified query (step 1430).

The SQL query may be determined based on the response generated by the LLM and this may be done based on the step 1350 of the method 1300.

The method 1400 includes storing the embedded modified query in the vector database in association with the SQL query and the dataset tag (step 1440).

The embedded modified query may be stored in the database in association with the SQL query and the dataset tag. In this manner, each time a new query is received, the system may generify the query and may store it in the vector database such that it may be identified as a similar query for future queries received.

The method 1400 enables the system to learn from prior queries by embedding and storing generified query representations in a structured, machine-optimized format. Through use of vector embeddings, dataset tagging, and SQL associations, the system allows future queries to be matched more efficiently and accurately.

Embodiments of the system described herein provides technical improvements in computer functionality by optimizing query processing. For example, by performing classification and entity extraction in parallel, and by applying dataset filters to reduce the search space within a vector database, system resources are conserved and processing speed is improved. Further, by generalizing queries and performing similarity searches on generified query vectors, the system avoids repetitive natural language parsing and enables efficient reuse of previously processed queries, reducing computational overhead.

Further, by mapping generified queries directly to structured SQL queries, the system may bypass complex query translation logic, resulting in faster response generation and reducing load on processing components. The system improves computer efficiency by reducing latency, minimizing memory and processor usage, and enabling scalable handling of natural language queries.

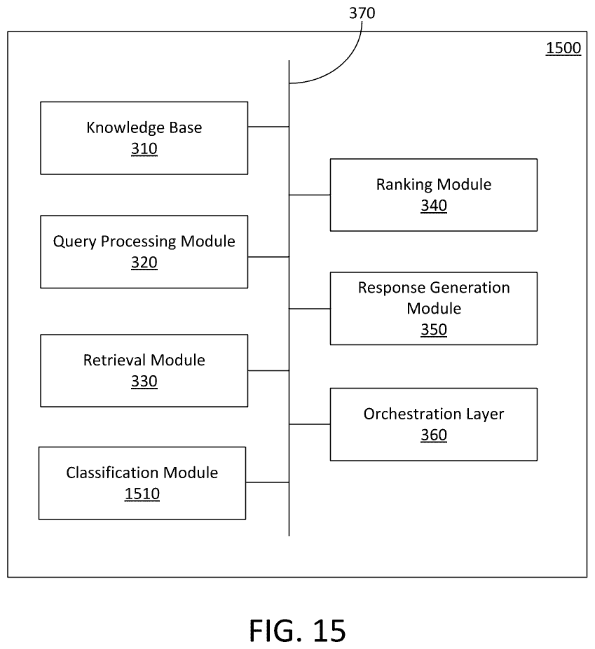

It will be appreciated that different modules may be combined to generate alternative embodiments of the engine. For example, another engine 1500 is shown in FIG. 15. The engine 1500 is generally similar to the engine 300 described herein with the following exception. In this embodiment, the engine 1500 includes a classification module 1510.

The classification module 1510 may be similar to the classification module 1210 described herein. For example, the classification module 1510 may use machine learning models, rule-based systems, or fine-tuned language models to classify a query into a particular category. The category may be used to filter the document corpus or to select a particular document corpus to be used for retrieval. For example, if a query is classified as a “holdings” question, the classification module 1510 may select a document corpus associated with holdings or may restrict retrieval to documents tagged with holding-related metadata. In addition, the classification module 1510 may be continuously updated and retrained with new data, allowing the system to adapt to emerging query patterns and evolving metadata, ensuring that the classification module 1510 stays current with new types of queries and changes to the underlying data.

The classification module 1510 may further refine retrieval by ensuring that only documents matching the query's classification category are considered. By integrating classification-based filtering before retrieval, the system improves precision and reduces noise in search results. Further, the system may periodically or continuously retrain the classification module 1510 using updated query logs, new user inputs, or feedback from the response generation process. In this manner, the system may adapt to shifts in query trends and the emergence of new categories, even as the types of queries evolve over time.

The classification module 1510 may be engaged prior to or during methods described herein. For example, the classification module 1510 may be engaged to classify a query and this may be done to select a particular document corpus that is to be used for retrieval.

In accordance with embodiments described herein, once the relevant documents have been retrieved, documents are provided to an LLM to generate a response to the original query. The LLM receives the documents and, if applicable, other information such as that described herein, to generate a response to the query. Such additional information may include, for example, the original query, a generified version of the query, an associated SQL query, one or more similar generified queries, metadata, classification results, etc. By supplying the LLM with both the retrieved documents and contextually relevant information, the system ensures that the response generation is both informed and accurate.

The systems and methods described herein enhance RAG pipelines by incorporating highly efficient and accurate document retrieval techniques. As described herein, documents may be retrieved using, among other techniques, one or more of query classification, entity recognition, generification, metadata extraction, metadata tagging, and vector similarity search within a filtered dataset. These layered and intelligent processes ensure that only the most contextually relevant documents are selected and passed to the LLM. As a result, the LLM is provided with high-quality, targeted input, thereby improving the relevance, precision, and factual grounding of the generated response.

The systems and methods described herein provide technical improvements to traditional RAG systems. By improving the document retrieval process prior to response generation, the system and methods described herein reduce the likelihood of irrelevant or low-quality data influencing the LLM's output. This yields a more accurate, efficient, and scalable system for generating responses to complex, structured, or domain-specific queries.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

1. A computer system comprising:
at least one processor; and
a memory coupled to the at least one processor and storing processor-executable instructions which, when executed by the at least one processor, configure the at least one processor to:
engage a classifier to classify a query and apply a dataset filter to a vector database based on a classification of the query to restrict the vector database to a filtered dataset of stored vectors having dataset tags corresponding to the classification of the query;
simultaneously identify at least one entity from the query;
modify the query to replace the identified at least one entity from the query with a generic placeholder to generate a modified query;
embed the modified query into a query vector;
perform a similarity search using the query vector within the filtered dataset in the vector database to select a stored vector corresponding to a similar query; and
extract, based on the selected stored vector, a Structured Query Language (SQL) query stored in association with the selected stored vector and provide the SQL query to a large language model to generate a response to the query.

2. The computer system of claim 1, wherein the vector database stores a plurality of vectors.

3. The computer system of claim 2, wherein each stored vector corresponds to an embedded query that is stored in association with a dataset tag and an SQL query.

4. (canceled)

5. The computer system of claim 1, wherein when performing the similarity search, the instructions, when executed by the at least one processor, further configure the at least one processor to:
compute similarity scores between the query vector and stored vectors in the vector database; and
select the stored vector based on the similarity scores.

6. The computer system of claim 5, wherein each similarity score is computed using one of cosine similarity or Euclidean distance.

7. The computer system of claim 1, wherein the classifier is trained to classify queries based on predefined dataset tags.

8. The computer system of claim 1, wherein performing the similarity search includes identifying a predefined number of candidate similar queries within the filtered dataset.

9. The computer system of claim 1, wherein the instructions, when executed by the at least one processor, further configure the at least one processor to:
determine a dataset tag based on the classification of the query;
determine an SQL query for the modified query; and
store the query vector in the vector database as a stored vector in association with the SQL query and the dataset tag.

10. The computer system of claim 1, wherein simultaneously identifying the at least one entity from the query comprises engaging a disambiguation engine to identify the at least one entity from the query.

11. A computer-implemented method comprising:
engaging a classifier to classify a query and apply a dataset filter to a vector database based on a classification of the query to restrict the vector database to a filtered dataset of stored vectors having dataset tags corresponding to the classification of the query;
simultaneously identifying at least one entity from the query;
modifying the query to replace the identified at least one entity from the query with a generic placeholder to generate a modified query;
embedding the modified query into a query vector;
performing a similarity search using the query vector within the filtered dataset in the vector database to select a stored vector corresponding to a similar query; and
extracting, based on the selected stored vector, a Structured Query Language (SQL) query stored in associated with the selected stored vector and provide the SQL query to a large language model to generate a response to the query.

12. The computer-implemented method of claim 11, wherein the vector database stores a plurality of vectors.

13. The computer-implemented method of claim 12, wherein each stored vector corresponds to an embedded query that is stored in association with a dataset tag and an SQL query.

14. (canceled)

15. The computer-implemented method of claim 11, further comprising:
computing similarity scores between the query vector and stored vectors in the vector database; and
selecting the stored vector based on the similarity scores.

16. The computer-implemented method of claim 15, wherein each similarity score is computed using one of cosine similarity or Euclidean distance.

17. The computer-implemented method of claim 11, wherein the classifier is trained to classify queries based on predefined dataset tags.

18. The computer-implemented method of claim 11, wherein performing the similarity search includes identifying a predefined number of candidate similar queries within the filtered dataset.

19. The computer-implemented method of claim 11, further comprising:
determining a dataset tag based on the classification of the query;
determining an SQL query for the modified query; and
storing the query vector in the vector database as a stored vector in association with the SQL query and the dataset tag.

20. A non-transitory computer readable storage medium comprising computer-executable instructions which, when executed, configure at least one processor to:
engage a classifier to classify a query and apply a dataset filter to a vector database based on a classification of the query to restrict the vector database to a filtered dataset of stored vectors having dataset tags corresponding to the classification of the query;
simultaneously identify at least one entity from the query;
modify the query to replace the identified at least one entity from the query with a generic placeholder to generate a modified query;
embed the modified query into a query vector;
perform a similarity search using the query vector within the filtered dataset in the vector database to select a stored vector corresponding to a similar query; and
extract, based on the selected stored vector, a Structured Query Language (SQL) query stored in association with the selected stored vector and provide the SQL query to a large language model to generate a response to the query.

21. The computer system of claim 1, wherein the instructions, when executed by the at least one processor, further configure the at least one processor to:
engage an orchestration layer to route the query between the classifier and the similarity search.
